(19) United States
(12) Patent Application Publication
(10) Pub. No.: US 2026/0327137 A1
(43) Pub. Date: Oct. 22, 2026

(54) METHOD FOR MANUFACTURING A GEOPOLYMER COMPOSITE BOARD REINFORCED WITH CARBON FIBERS

(71) Applicant: Ibrahim M. ALARIFI, Al Majma'ah (SA)

(72) Inventors: Ibrahim M. ALARIFI, Al Majma'ah (SA); Tarek Mohamed Ahmed Ali EL-BAGORY, Al Majma'ah (SA); Abdulrahman Ibrahim ALFANTOUKH, Al Majma'ah (SA); Ammar Abdul-Aziz ALSALAMAH, Al Majma'ah (SA); Rayan Khaled ARRODHAN, Al Majma'ah (SA); Ali Mazyad ALMUTAIRI, Al Majma'ah (SA)

(21) Appl. No.: 19/688,467

(22) Filed: May 26, 2026

(51) Int. Cl. C04B 28/00; B28B 1/087; C04B 14/38; C04B 22/06; C04B 40/00; C04B 103/10

(52) U.S. Cl. CPC C04B 28/006; B28B 1/087; C04B 14/386; C04B 22/062; C04B 40/0046; C04B 40/0067; C04B 40/0082; C04B 2103/10

(57) ABSTRACT

The present invention relates to a method for manufacturing a geopolymer composite board reinforced with carbon fibers, and a composition thereof. The prepared composite is made from ash of palm leaves, sodium hydroxide pellets with percentages concentration 20% and 30% and reinforced with short carbon fibers such as black carbon fibers. The experimental work of geopolymer material is conducted on two different tests namely; compression and absorption test. Compression test is conducted on three compression test specimens with concentration 20% and 30% from sodium hydroxide with and without carbon fiber. The absorption test studied at testing times ranging from 30 to 3000 sec. The absorption test specimen is prepared with two percentage concentrations from sodium hydroxide and without carbon fiber. The final results revealed that increasing the percentage of sodium hydroxide and addition carbon fibers have a significant effect of on both mechanical and absorption properties of geopolymer composites material.

### FIELD OF THE INVENTION

The present disclosure relates to the field of manufacturing geopolymer composite, specifically a method for manufacturing a geopolymer composite board reinforced with carbon fibers, and composition thereof. In more particular manner, the present invention relates to a geopolymer composite board comprising ash of palm, sodium hydroxide pellets, and reinforced with short carbon fibers such as black carbon fibers.

### BACKGROUND OF THE INVENTION

The global planet temperature has risen to 2 degrees Celsius until now, and there are not enough steps taken to stop it. Overall, climate change is an alarming situation, and carbon emissions have a significant impact if carbon emissions continue to increase without any appreciable measures taken to resolve this issue. An alternative is to use eco-friendly geopolymers instead of concrete. It is a mixture of liquid and can be molded into a complex design by the conventional casting process. They do not need any heat treatment and can quickly be processed at room temperature. Geopolymers are prepared by mixing aluminosilicate into an alkaline solution which forms the solution of water glass (metal ions & silica fumes) in which metakaolin is dissolved by alkaline.

Geopolymer is a mixture of liquids and can be fabricated into complex design simply by using the mold casting technique. These materials don't require high temperature for the curing process; they are commonly manufactured at room temperature. Geopolymer is manufactured into three steps. In the first step, aluminosilicate and alkaline solutions form a water glass solution in which metakaolin is dissolved by alkaline. Geopolymers possess high mechanical strength and high inertness against chemical reactions. It has high thermal shock resistance and ambient temperature stability. The structural study of potassium geopolymer shows that the homogeneity of potassium particles within the structure is more uniform than cesium and sodium. In terms of strength, cement boards relatively show higher load-bearing properties than the board of cement fiber; furthermore, these cement boards allow multiple thicknesses. The absorption of Sulphur is processed by adding limestone through desulphurization, which then produces slag. The product obtained by passing the material through all these steps is used in different places.

Fiber-reinforced geopolymer composites are the best choice for structural applications, such as bridges and building structures. This is due to their high impact strength; they can be good energy absorbers. Their fracture mechanism shows deflection of crack propagation which improved the energy absorption in quasi-static fracture. Moreover, they can be applied to absorb mechanical energy under high impact and high strain rates.

Concrete has been the most widely used synthetic material until now. Most of our infrastructure is made up of concrete. It also has a massive carbon footprint. It is the source of about (8%) of the world's carbon dioxide (CO2) emissions; if the cement industry were a country, it would be the third-largest emitter in the world—behind China and the US. It contributes more CO2 than aviation fuel (2.5%) and is not far behind the global agriculture business (12%). The carbon emission by geopolymers is 0.2 tons per ton of material, which means an 80% reduction compared to concrete. The raw material of geopolymer is also very abundant, which means its low cost of production. However, geopolymers have brittle properties naturally, which means they possess high impact strength but low compressive strength. This means if a crack occurs during its curing process or while using it. The damage will be propagated further until the whole structure collapse and overcome this drawback. Several additives have been tried to compensate for this limitation of geopolymers, such as fly ash and carbon fibers.

In the view of the foregoing discussion, it is clearly shown that there is a need for manufacturing geopolymer composite that includes percentage concentration of sodium hydroxide with addition of carbon fibers for reinforcement.

### SUMMARY OF THE INVENTION

The present disclosure relates to a method for manufacturing a geopolymer composite board reinforced with carbon fibers, and composition thereof. The prepared geopolymer composite includes ash of palm leaves, and sodium hydroxide pellets with percentage concentration of 20% and 30%, wherein the geopolymer composite is reinforced with short carbon fibers such as black carbon fibers. The experimental work of geopolymer material is conducted on two different tests namely; compression and absorption test. Compression test is conducted on three compression test specimens with concentration 20% and 30% from sodium hydroxide with and without carbon fiber. Furthermore, the absorption test studied at testing times ranging from 30 to 3000 sec. The absorption test specimen is prepared with two percentage concentrations from sodium hydroxide and without carbon fiber. The final results revealed that increasing the percentage of sodium hydroxide and addition carbon fibers have a significant effect of on both mechanical and absorption properties of geopolymer composites material.

An object of the present disclosure is to provide a geopolymer composite board, reinforced with carbon fibers, comprising five different components, including, ash of palm leaves, sodium hydroxide pellets, carbon fiber mesh, distilled water, and sika powder.

Another object of the present disclosure is to analyze the influence of the percentage concentration for sodium hydroxide and addition of carbon fibers with each percentage on the mechanical properties of the geopolymer under compression test.

Another object of the present disclosure is to analyze the fracture pattern, to determine the effects of geopolymer composition on fracture behavior.

Another object of the present disclosure is to analyze the effect of percentage concentration of sodium hydroxide on the absorption properties at different testing times. The calculation method of the weight of absorbed water per unit area is applied to comparison between all different percentage concentrations.

Another object of the present disclosure is to describe the mechanical and absorption properties of the geopolymer based on various compositions from ash of palm leaves, sodium hydroxide pellet with percentage concentration 20% and 30%, and reinforced with short carbon fibers such as black carbon fibers.

Yet, another object of the present disclosure is to provide a geopolymer composite as an eco-friendly alternative to the traditional cement ingredients used in concrete.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates geopolymer board reinforced composite manufactured process.

FIG. 2 illustrates a diagram showing the geopolymer composite board reinforced with short carbon fibers, in accordance with an embodiment of the present disclosure;

FIG. 3A illustrates fly ashes being put into the compact machine for filtering, in accordance with an embodiment of the present disclosure;

FIG. 3B illustrates configuration of the compact machine, in accordance with an embodiment of the present disclosure;

FIG. 3C illustrates the filtered fly ash, having diameter of 0.425 mm, filtered using compact machine, in accordance with an embodiment of the present disclosure;

FIG. 4 illustrates photographic configuration of stirrer plate, in accordance with an embodiment of the present disclosure;

FIG. 5A illustrates weighing the mixture of mortar and cement paste, in a vessel of mortar mixture, in accordance with an embodiment of the present disclosure;

FIG. 5B illustrates the configuration of the mortar mixture, in accordance with an embodiment of the present disclosure;

FIG. 6 illustrates the photographic configuration of shaker table, in accordance with an embodiment of the present disclosure;

FIG. 7 illustrates a photographic configuration of drying the specimen at room temperature, in accordance with an embodiment of the present disclosure;

FIG. 8 illustrates composite specimen removed from molds after drying, in accordance with an embodiment of the present disclosure;

FIG. 9A illustrates specimens prepared for the compression tests, in accordance with an embodiment of the present disclosure;

FIG. 9B illustrates specimens prepared for absorption tests, in accordance with an embodiment of the present disclosure;

FIG. 10A illustrates the dimension of the compression test specimen based on geopolymer composite material, without carbon fiber, in accordance with an embodiment of the present disclosure;

FIG. 10B illustrates the dimension of the compression test specimen based on geopolymer composite material, with carbon fiber at 20% and 30%, in accordance with an embodiment of the present disclosure;

FIG. 11A illustrates a table showing main dimensions of three compression test specimens for different types of geopolymer, in accordance with an embodiment of the present disclosure;

FIG. 11B illustrates a table showing the minimum and maximum deviation in the outer diameter of three compression test specimens for different types of geopolymer, in accordance with an embodiment of the present disclosure;

FIG. 12 illustrates dimensions of absorption test specimen for geopolymer composite material with sodium hydroxide in 20% and 30% concentration, in accordance with an embodiment of the present disclosure;

FIG. 13 illustrates a table showing main dimension of two adsorption test specimens for different types of geopolymer, in accordance with an embodiment of the present disclosure;

FIG. 14 illustrates a graphical representation of load versus crosshead displacement for composite geopolymer material with percentage 20% sodium hydroxide pellets, in accordance with an embodiment of the present disclosure;

FIG. 15 illustrates a table showing the final results of load displacement curve for all types of composite geopolymer material, in accordance with an embodiment of the present disclosure;

FIG. 16A illustrates fracture surface for first compression test specimen from geopolymer material with 20% S, in accordance with an embodiment of the present disclosure;

FIG. 16B illustrates fracture surface for second compression test specimen from geopolymer material with 20% S, in accordance with an embodiment of the present disclosure;

FIG. 16C illustrates fracture surface for third compression test specimen from geopolymer material with 20% S, in accordance with an embodiment of the present disclosure;

FIG. 17 illustrates load versus crosshead displacement for composite geopolymer material with 30% S, in accordance with an embodiment of the present disclosure;

FIG. 18A illustrates fracture surface for first compression test specimen from geopolymer material with 30% S, in accordance with an embodiment of the present disclosure;

FIG. 18B fracture surface for second compression test specimen from geopolymer material with 30% S, in accordance with an embodiment of the present disclosure;

FIG. 18C fracture surface for third compression test specimen from geopolymer material with 30% S, in accordance with an embodiment of the present disclosure;

FIG. 19 illustrates load versus crosshead displacement for composite geopolymer material with percentage 20% sodium hydroxide pellets and carbon fiber, in accordance with an embodiment of the present disclosure;

FIG. 20A illustrates fracture surface for first compression test specimen from geopolymer material with 20% S and carbon fiber, in accordance with an embodiment of the present disclosure;

FIG. 20B illustrates fracture surface for second compression test specimen from geopolymer material with 20% S and carbon fiber, in accordance with an embodiment of the present disclosure;

FIG. 20C illustrates fracture surface for third compression test specimen from geopolymer material with 20% S and carbon fiber, in accordance with an embodiment of the present disclosure;

FIG. 21 load versus crosshead displacement for composite geopolymer material with percentage 30% sodium hydroxide pellets and carbon fiber, in accordance with an embodiment of the present disclosure;

FIG. 22A illustrates fracture surface for first compression test specimen from geopolymer material with 30% S and carbon fiber, in accordance with an embodiment of the present disclosure;

FIG. 22B illustrates fracture surface for second compression test specimen from geopolymer material with 30% S and carbon fiber, in accordance with an embodiment of the present disclosure;

FIG. 22C illustrates fracture surface for third compression test specimen from geopolymer material with 30% S and carbon fiber, in accordance with an embodiment of the present disclosure;

FIG. 23 illustrates engineering compression stress-strain curves for all types of composite geopolymer material with percentage 20% and 30% sodium, with and without carbon fiber, in accordance with an embodiment of the present disclosure;

FIG. 24 illustrates a table showing the mechanical properties of four different variations of a geopolymer composite material, in accordance with an embodiment of the present disclosure;

FIG. 25 illustrates a graphical representation of apparent young's modulus for all types of composite geopolymer material with percentage 20% and 30% sodium, with and without carbon fiber, in accordance with an embodiment of the present disclosure;

FIG. 26 illustrate compression yield's stress for all types of composite geopolymer material with percentage 20% and 30% sodium, with and without carbon fiber, in accordance with an embodiment of the present disclosure;

FIG. 27 illustrates apparent compression yield strain for all types of composite geopolymer material with percentage 20% and 30% sodium, with and without carbon fiber, in accordance with an embodiment of the present disclosure;

FIG. 28 illustrates apparent modulus of toughness for all types of composite geopolymer material with percentage 20% and 30% sodium, with and without carbon fiber, in accordance with an embodiment of the present disclosure;

FIG. 29 illustrates normalized stiffness (E/Emax), for all types of composite geopolymer material with percentage 20% and 30% sodium, with and without carbon fiber, in accordance with an embodiment of the present disclosure;

FIG. 30 illustrates normalized toughness (MT/MTmax), for all types of composite geopolymer material with percentage 20% and 30% sodium, with and without carbon fiber, in accordance with an embodiment of the present disclosure;

FIG. 31A illustrates SEM morphology of palm ash and 20% sodium, in accordance with an embodiment of the present disclosure;

FIG. 31B illustrates SEM morphology of palm ash and 20% sodium with carbon, in accordance with an embodiment of the present disclosure;

FIG. 32A illustrates SEM morphology of palm ash and 30% sodium, in accordance with an embodiment of the present disclosure;

FIG. 32B illustrates SEM morphology of palm ash and 30% sodium with carbon, in accordance with an embodiment of the present disclosure;

FIG. 33 illustrates a table showing results of absorption properties for geopolymer composites based on two different percentages of sodium hydroxide and two specimens in each absorption test, in accordance with an embodiment of the present disclosure;

FIG. 34 illustrates weight of absorbed water versus time for geopolymer composites with two different percentages of sodium hydroxide 20% and 30% with two specimens in each percentage, in accordance with an embodiment of the present disclosure;

FIG. 35 illustrates weight of absorbed water per unit area versus time for geopolymer composites with two different percentages of sodium hydroxide 20% and 30% with two specimens in each percentage, in accordance with an embodiment of the present disclosure;

FIG. 36 illustrates a flow chart for a method for manufacturing a carbon fiber reinforced geopolymer composite board; and

FIG. 37 illustrates a block diagram for a system for manufacturing a carbon fiber reinforced geopolymer composite board.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. It will be understood by those skilled in the art that the foregoing general description and the following detailed description are exemplary and explanatory of the invention and are not intended to be restrictive thereof. Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment. The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Unless otherwise defined, all technical and scientific terms used herein have the same meaning as commonly understood by one of ordinary skill in the art to which this invention belongs. The system, methods, and examples provided herein are illustrative only and not intended to be limiting. Embodiments of the present disclosure will be described below in detail with reference to the accompanying drawings.

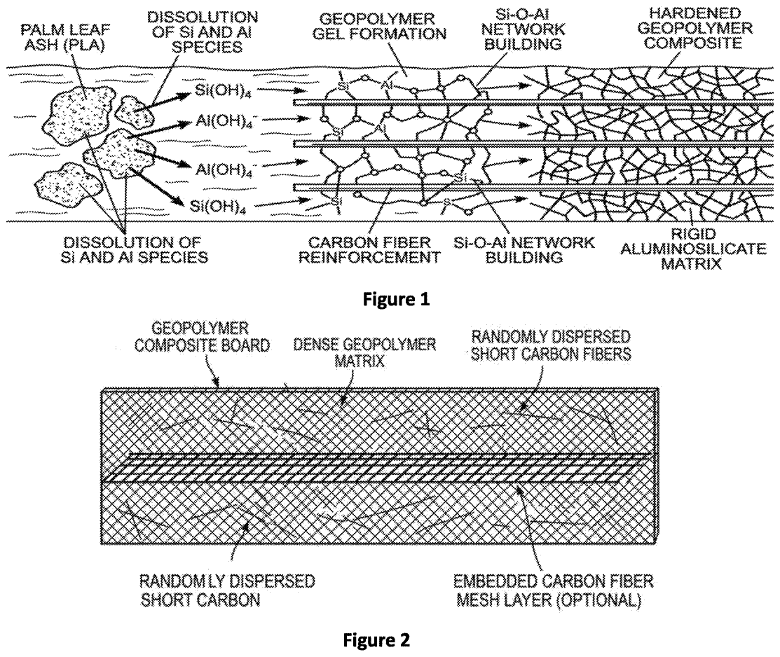

FIG. 1 illustrates geopolymer board reinforced composite manufactured process. Geopolymer is a mixture of liquids and can be fabricated into complex design simply by using the mold casting technique. These materials don't require high temperature for the curing process; they are commonly manufactured at room temperature. As shown in FIG. 1, geopolymer is manufactured into three steps, beginning with the dissolution of silicon (Si) and aluminum (Al) species from a precursor material, such as palm leaf ash, into a reactive solution. This is followed by the formation of a geopolymer gel where these dissolved species undergo polycondensation to initiate the development of a Si—O—Al inorganic network around embedded carbon fiber reinforcements. Finally, this gel structure undergoes hardening and densification, resulting in a rigid, three-dimensional aluminosilicate matrix that encapsulates the reinforcing fibers to form the final high-strength geopolymer composite. The present invention relates to a method for constructing geopolymer composite board reinforced with carbon fibers, and a composition thereof. The geopolymer composite is prepared by using ash of palm leaves, sodium hydroxide pellets with percentages concentration 20% and 30%, and short carbon fibers for reinforcement, such as black carbon fibers. FIG. 2 illustrates a diagram showing the geopolymer composite board reinforced with short carbon fibers, in accordance with an embodiment of the present disclosure.

In a preferred embodiment, the geopolymer composite material consists of five different items as the following: ash of palm leaves, sodium hydroxide pellets, carbon fiber mesh, distilled water and sika powder. The first component of composite material is the ash of palm leaves which is produced from burning and crushing the palm leaves and then filtered from impurities. Sodium hydroxide pellets is the second component in the composite material and known as lye and caustic soda is an inorganic compound with the formula Na—OH. On the other hand, the sodium hydroxide pellets is added in the composite material by two different percentages equal 20% and 30%. The third component is carbon fiber mesh which is used to improve the performance of concrete structures. High strength, high modulus resistance to creep and excellent fatigue properties are the most important mechanical properties of carbon fiber which allow the carbon grid to provide with excellent structural reinforcement. The fourth component is distilled water that has been boiled into vapor and condensed back into liquid in a separate container. The distilled water is used to help the component of composite material becomes homogeneous during the mixing of components. The last component is watertight concrete powder which is used to enhance the workability and reduce the water permeability for the composite material.

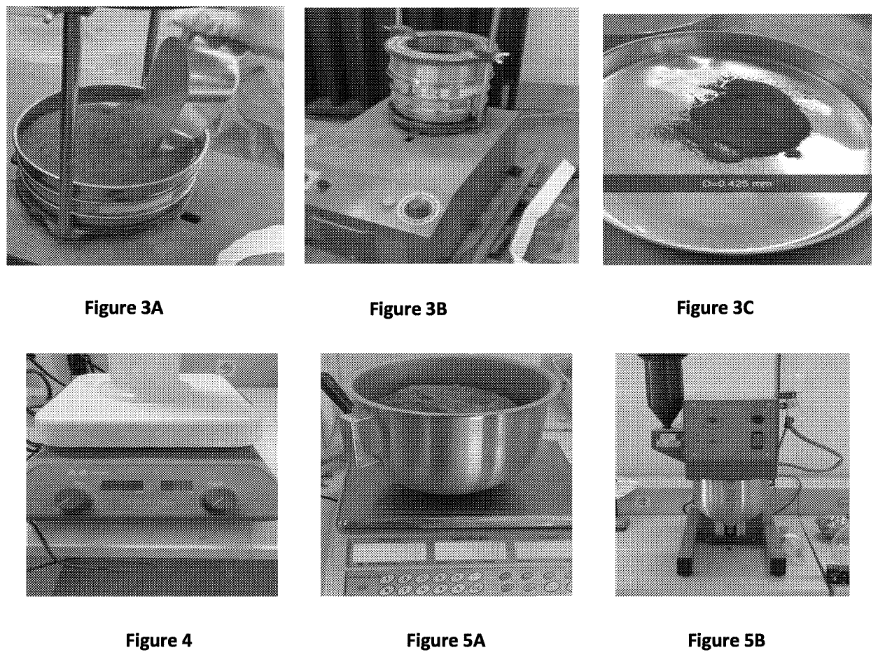

FIG. 3A illustrates fly ashes being put into the compact machine for filtering, in accordance with an embodiment of the present disclosure; FIG. 3B illustrates configuration of the compact machine, in accordance with an embodiment of the present disclosure; FIG. 3C illustrates the filtered fly ash, having diameter of 0.425 mm, filtered using compact machine, in accordance with an embodiment of the present disclosure.

The manufacturing process of geopolymer is depending on different stages to produce new composite material of geopolymer compared with the traditional geopolymer material. The first stage is prepared the ash by burning of the palm leaves in a clean and isolated place. The types of ashes are classified into three classes, namely N, F, and C, based on the manufacturing process and production of ash, wherein the class F is used as a type of manufacturing of ash. The ashes are filetered from impurities by using a compact machine, as shown in FIG. 3A, and FIG. 3B, based on vibration technique to improve the quality of ashes. The ash is filtered using said compact machine, wherein filtered ash is shown in FIG. 3C.

FIG. 4 illustrates photographic configuration of stirrer plate, in accordance with an embodiment of the present disclosure. The second operation of the preparation of the new composite material (geopolymer composite) includes the mixing of sodium hydroxide pellets at different percentages (20% and 30%) with distilled water using stirrer plate, and make sure it is fully homogeneous solution. A stirrer plate is employed for mixing, wherein the stirrer plate employs a rotating magnetic field to cause a stir bar immersed in a liquid to spin very quickly, thus stirring it. The rotating field may be created either by a rotating magnet or a set of stationary electromagnets, placed beneath the vessel with the liquid as illustrated in FIG. 4.

The third operation of the manufacturing of geopolymer composite includes addition of Na—OH solution by to the fly ash in mortar mixer then stir until it be a homogeneous mixture. FIG. 5A illustrates weighing the mixture of mortar and cement paste, in a vessel of mortar mixture, in accordance with an embodiment of the present disclosure. FIG. 5B illustrates the configuration of the mortar mixture, in accordance with an embodiment of the present disclosure. Mortar mixer is designed to mix mortar and cement paste to standard requirements and can be operated in either manually or automatic. Homogeneous mixture is a combination of two or more substances in any proportion. This is different from a compound, which consists of substances in fixed proportions. The substances in a mixture also do not combine chemically to form a new substance, as they do in a compound. Instead, they just intermingle and keep their original properties.

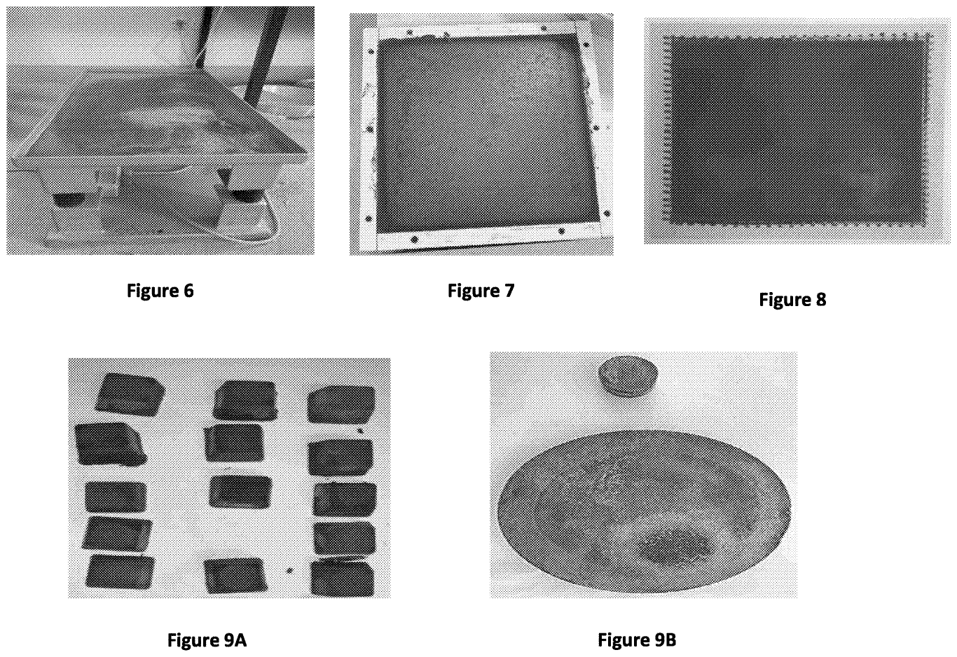

FIG. 6 illustrates the photographic configuration of shaker table, in accordance with an embodiment of the present disclosure. The Fourth step in the manufacturing of composite is pouring the mixture into the mold and put the mold on the shaker table, as shown in FIG. 6, in order to remove the air bubbles. A shaker table is an oscillating platform that can be used to test structures by simulating earthquakes

FIG. 7 illustrates a photographic configuration of drying the specimen at room temperature, in accordance with an embodiment of the present disclosure. The specimen is left for complete drying at room temperature. FIG. 8 illustrates composite specimen removed from molds after drying, in accordance with an embodiment of the present disclosure. The specimen is removed from the molds after they are dry.

FIG. 9A and FIG. 9B illustrates specimens prepared for the compression and absorption tests, respectively, in accordance with an embodiment of the present disclosure. The prepared specimens of the manufactured geopolymer composite are subjected to two different tests, namely compression test and absorption test. The compression tests are conducted at room temperature, Ta=20 °C and crosshead speed, V_{C.H} equal 10 mm/min for all types. The compression test has been tested for compressive strength of cylindrical concrete specimens, as shown in FIG. 9A. This test method covers determination of compressive strength of cylindrical concrete specimens such as molded cylinders and drilled cores. It is limited to concrete having a density in excess of 800 kg/m³. The water absorption test is conducted, in which, water absorption characteristics of geopolymer is studied for 90 days, wherein the specimens used for this test was cubes of size 100 mm×100 mm, as shown in FIG. 9B. The specimens cured at 90 °C in dry air oven for 24 hours then all the specimens were cured for 90 days at room temperature in ambient curing. The difference between the saturated mass and oven dried mass of the specimens. For the absorption test, the requirement includes pan filled up to 1-3 mm above the support rods with deionized water, plastic sheet and sealing tape to make sure that the specimen is absorbing the water from bottom only. First the measurements of the dry and treated specimen are taken and the values on the data collection sheet are recorded, then the dry specimen is weighed and the value as M₀ is recorded. The specimen is kept in the water and the stop watch is started for 30 seconds, then the specimen is removed from the water, the weight data is taken and recorded as Mt. Repeat the weighing procedure at 1, 2, 5, 10, 15, 30, 60 minutes.

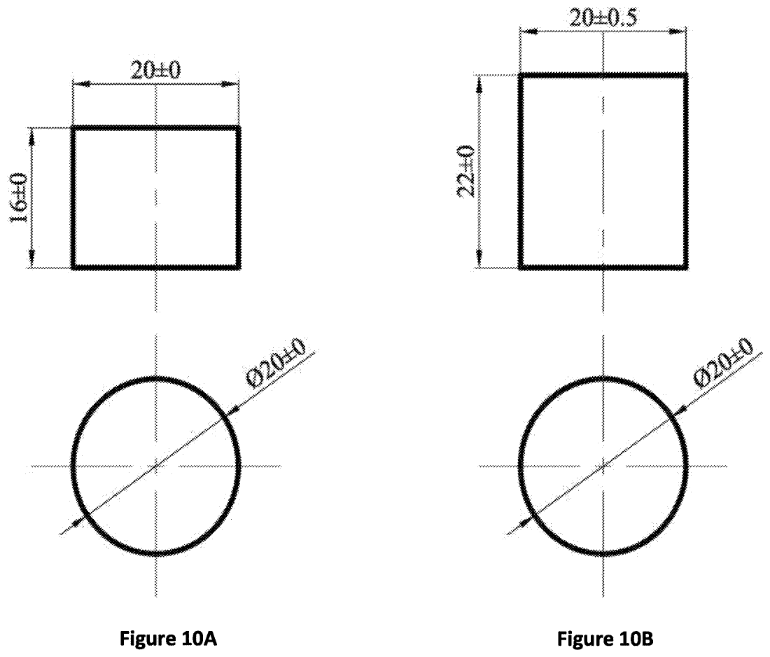

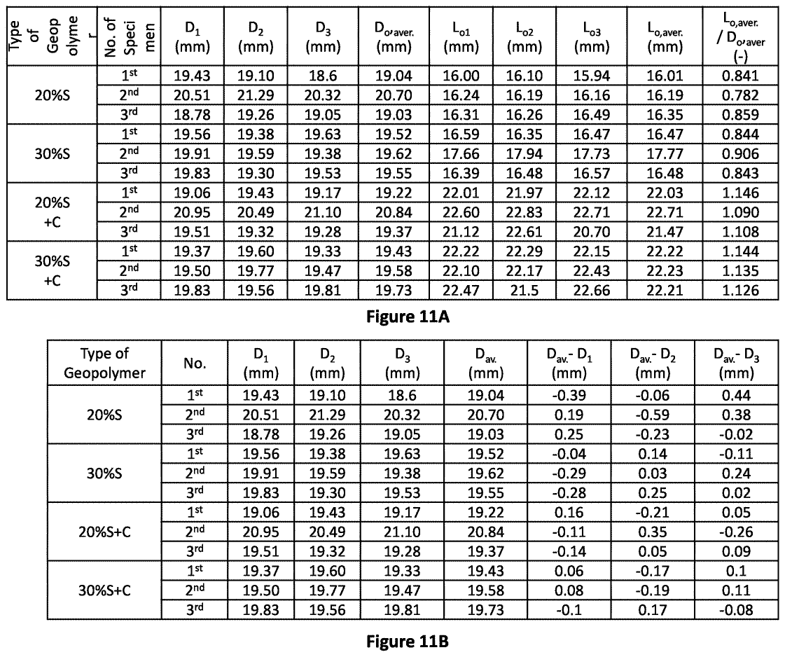

FIG. 10A illustrates the dimension of the compression test specimen based on geopolymer composite material, without carbon fiber, in accordance with an embodiment of the present disclosure. FIG. 10B illustrates the dimension of the compression test specimen based on geopolymer composite material, with carbon fiber at 20% and 30%, in accordance with an embodiment of the present disclosure. Drilled core method is the most suitable and adequate methods for manufacturing the compression test specimen made from geopolymer composites material. The dimensions of compression test specimen for all types of geopolymer composites using in the present study have identical dimensions with different percentage compositions of geopolymer. The identical configuration and high accuracy for the dimensions of compression test specimens are minimized the percentage difference in the final results. All dimensions of compression test specimen are used according to standards ASTM C39/39M-21 and D1633-17, as shown in FIG. 10A, and FIG. 10B. The total number of compression test specimens for each type of geopolymer is three specimens at the same manufacturing conditions. FIG. 11A illustrates a table showing main dimensions of three compression test specimens for different types of geopolymer, in accordance with an embodiment of the present disclosure. The average outer diameter, D_{o,aver.} is calculated based on three different diameters, (D₁, D₂ and D₃) at different positions of measuring along the length of compression specimen. On the other hand, the average overall length, L_{o,aver.} is calculated according to measure three outer lengths, (L₁, L₂ and L₃) from top to bottom surfaces of compression test specimen. FIG. 11B illustrates a table showing the minimum and maximum deviation in the outer diameter of three compression test specimens for different types of geopolymer, in accordance with an embodiment of the present disclosure. The minimum and maximum deviation in the outer diameter is −0.59 and +0.44 mm respectively. This means that, the percentages of minimum and maximum deviation in the diameter relative to average outer diameter, D_{o,aver} are −2.85% and 2.31% respectively. The values of percentage deviation in the outer diameter are revealed that the accuracy of manufacturing process of compression specimen gives diameter accuracy not less than 97%.

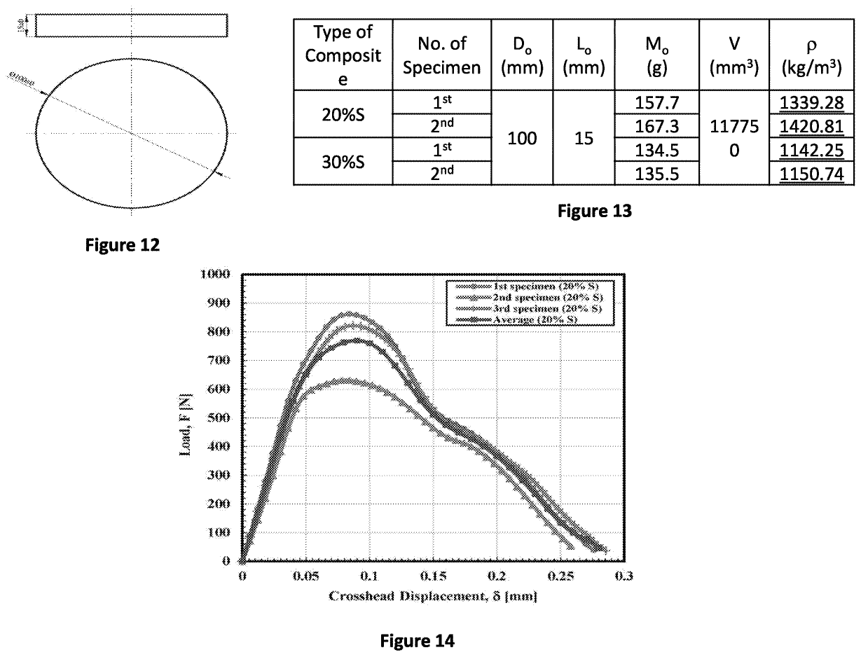

FIG. 12 illustrates dimensions of absorption test specimen for geopolymer composite material with sodium hydroxide in 20% and 30% concentration, in accordance with an embodiment of the present disclosure. The water absorption test of geopolymer composite material has been tested according to ASTM C 642-21. The absorption specimens used for this test were prepared from cubes of size 100 mm×100 mm. The main dimensions of cylindrical absorption test specimens were configured by water jet machine. This test studies the water absorption characteristics of Geopolymer and 90 days, the specimens used for this test were cubes of size 100 mm×100 mm. The specimens cured at 90 °C in dry air oven for 24 hours then all the specimens were cured for 90 days at room temperature in ambient curing. The difference between the saturated mass and oven dried mass of the specimens. For performing the test, a Pan is filled up to 1-3 mm above the support rods with deionized water, plastic sheet and sealed tape is used to make sure that the specimen is absorbing the water from bottom only. For performing the test, first the measurements of the dry and treated specimen are taken and the values on the data collection sheet are recorded, then the dry specimen is weighed and the value as M0 is recorded. The specimen is kept in the water and the stop watch is started for 30 seconds, then the specimen is removed from the water, and weighed, and the weighed data is recorded as Mt. Repeat the weighing procedure at 1, 2, 5, 10, 15, 30, 60 minutes.

ΔMₜ (g)=Mₜ (g)−Mₒ (g) (1)
where:
Mₜ (g): is the weight of the specimen at time t (g),
Mₒ (g): is the dry weight of the specimen at time t=0 (g),
ΔMₜ (g): is the weight of absorbed water after time t (g).

$$Δ {M}_{t} ( \% ) = \frac{Mt ( g ) - Mo ( g )}{Mo ( g )} \times 100 \qquad ( 2 )$$

where:
ΔMt (%): is percentage of the weight of absorbed water after time t, %

$$m = \frac{Δ {M}_{t} ( g )}{\frac{π}{4} \times {D}_{o}^{2}} \times 1 {0}^{3} \qquad ( 3 )$$

where:
m: is the weight of absorbed water per unit area (kg/m²),
D_{o:} is the outer diameter of absorption test specimen (mm),
ΔMt (g): is the weight of absorbed water after time t (g) according to Eq. no. 1.

FIG. 13 illustrates a table showing main dimension of two adsorption test specimens for different types of geopolymer, in accordance with an embodiment of the present disclosure.

The experimental results of composite geopolymer material are revealed that a pronounced effect of the percentages for sodium hydroxide pellets and carbon fiber on the mechanical behavior of composite geopolymer material under compression test. The experimental compression test is conducted at constant crosshead speed equal 10 mm/min and constant environmental temperature 20 °C for all types of composite geopolymer material.

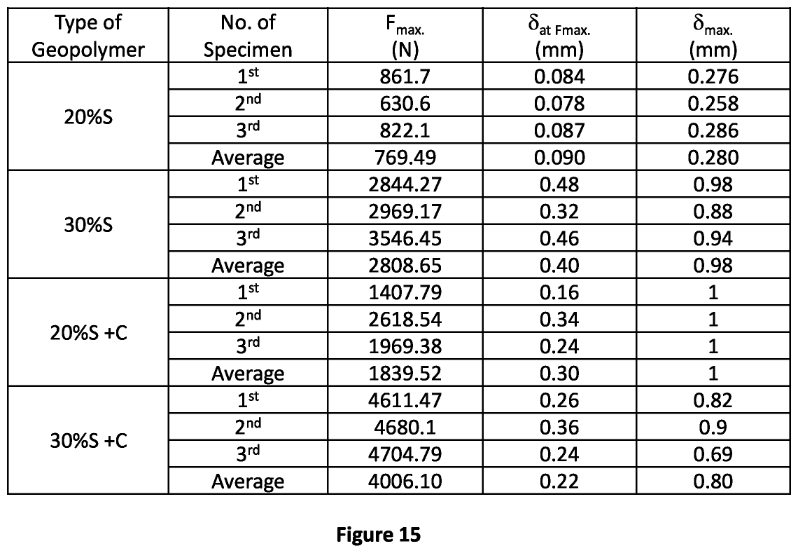

FIG. 14 illustrates a graphical representation of load versus crosshead displacement for composite geopolymer material with percentage 20% sodium hydroxide pellets, in accordance with an embodiment of the present disclosure. FIG. 14 illustrates the curves of applied compression load, F versus crosshead displacement, δ for three specimens of composite geopolymer material with percentage 20% sodium hydroxide pellets. In order to improve the accuracy of the final results, three identical compression specimens are tested at the same loading conditions. On the other hand, an average curve takes for all the compression specimen curves according to fitting curve. The behavior of load displacement curve for the first and third specimen is more identical compared with the curve of second specimen. The maximum load for 1^{st} and 3^{rd} specimens is ≅862 and 822 [N] respectively while the maximum load is equal ≅631 [N] for 2^{nd} specimen. This difference in the behavior between all specimens is depending on the manufacturing, drying processes and location of compression specimen in the plate of composite material. The compression results revealed also, the displacement at maximum force, (δ_{at Fmax}.) and maximum compression displacement, δ_{max.} is approximately constant for all specimens with percentage 20% sodium hydroxide pellets. The average curve for the three specimens of composite geopolymer material is determined according to Curve Expert Professional program ver. 1.6.5. FIG. 15 illustrates a table showing the final results of load displacement curve for all types of composite geopolymer material, in accordance with an embodiment of the present disclosure. The table shows in FIG. 15, shows that maximum load and displacement for the average curve are equal 769.49 [N] and 0.28 [mm] respectively based on polynomial equation fitting. The configuration of fracture surface for compression test specimen is classified into six standard fracture patterns according to ASTM C39/C39M-21 based on the fracture pattern on the compression specimen. On the other hand, the fracture pattern is different from specimen to another based on the material composition of geopolymer.

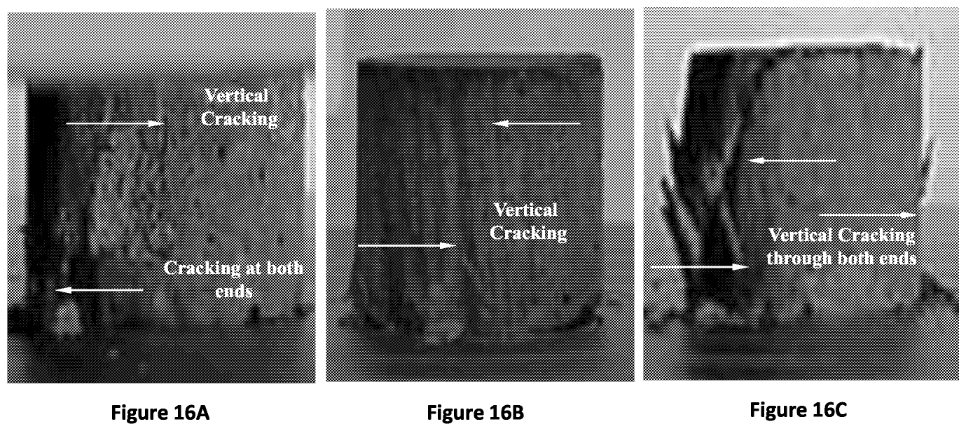

FIG. 16A illustrates fracture surface for first compression test specimen from geopolymer material with 20% S, in accordance with an embodiment of the present disclosure. FIG. 16B illustrates fracture surface for second compression test specimen from geopolymer material with 20% S, in accordance with an embodiment of the present disclosure. FIG. 16C illustrates fracture surface for third compression test specimen from geopolymer material with 20% S, in accordance with an embodiment of the present disclosure. All specimens are tested at the same operating conditions and nearly identical dimensions in order to minimize the variation in the experimental results during the analysis. The photographic of fracture surfaces are revealed that the fracture pattern is compatible with pattern type 3 according to the location and orientation of crack path on the test specimen surface and also the crack location on both ends. Additionally, the photographic configuration for all specimens revealed that vertical cracks for both sides of compression specimen.

The experimental results demonstrated that increasing the percentage of sodium hydroxide pellets in the composite geopolymer material plays an important and effect role in the mechanical behavior under compression loading. This effect is studied on three identical compression specimens for percentage 30% of sodium hydroxide to comparison the difference in the mechanical behavior between percentage 20% and 30%.

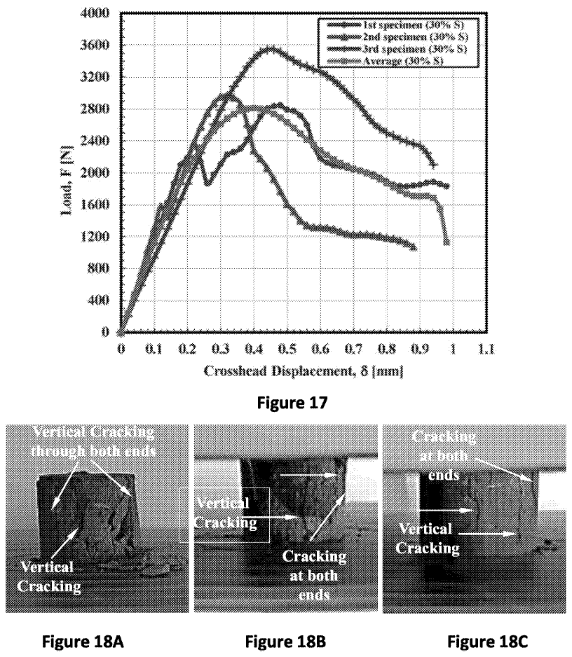

FIG. 17 illustrates load versus crosshead displacement for composite geopolymer material with 30% S, in accordance with an embodiment of the present disclosure. FIG. 17 shows the load displacement curves for three compression specimens of composite geopolymer material with percentage 30% sodium hydroxide pellets, wherein the maximum load and maximum displacement are more different with the percentage 30% compared with percentage 20% sodium hydroxide pellets.

FIG. 18A illustrates fracture surface for first compression test specimen from geopolymer material with 30% S, in accordance with an embodiment of the present disclosure. FIG. 18B fracture surface for second compression test specimen from geopolymer material with 30% S, in accordance with an embodiment of the present disclosure. FIG. 18C fracture surface for third compression test specimen from geopolymer material with 30% S, in accordance with an embodiment of the present disclosure. The fracture surface shows Fracture Pattern Type 3, columnar vertical cracking through both ends no well-formed cons according to ASTM C39/C39M-09a.

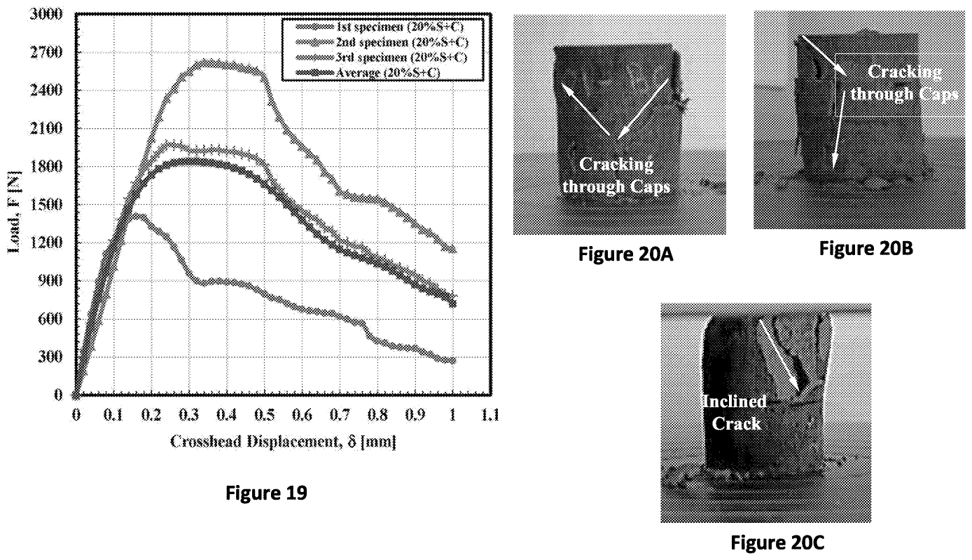

FIG. 19 illustrates load versus crosshead displacement for composite geopolymer material with percentage 20% sodium hydroxide pellets and carbon fiber, in accordance with an embodiment of the present disclosure.

FIG. 20A illustrates fracture surface for first compression test specimen from geopolymer material with 20% S and carbon fiber, in accordance with an embodiment of the present disclosure. FIG. 20B illustrates fracture surface for second compression test specimen from geopolymer material with 20% S and carbon fiber, in accordance with an embodiment of the present disclosure. FIG. 20C illustrates fracture surface for third compression test specimen from geopolymer material with 20% S and carbon fiber, in accordance with an embodiment of the present disclosure. The fracture surface shows Fracture Pattern Type 1, columnar vertical cracking through both ends no well-formed cons according to ASTM C39/C39M-09a.

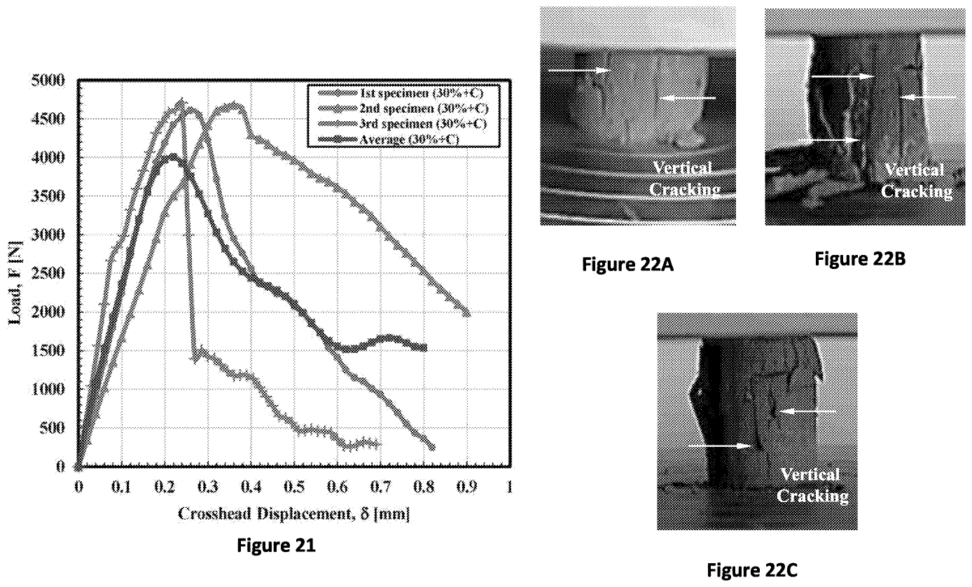

FIG. 21 load versus crosshead displacement for composite geopolymer material with percentage 30% sodium hydroxide pellets and carbon fiber, in accordance with an embodiment of the present disclosure.

FIG. 22A illustrates fracture surface for first compression test specimen from geopolymer material with 30% S and carbon fiber, in accordance with an embodiment of the present disclosure. FIG. 22B illustrates fracture surface for second compression test specimen from geopolymer material with 30% S and carbon fiber, in accordance with an embodiment of the present disclosure. FIG. 22C illustrates fracture surface for third compression test specimen from geopolymer material with 30% S and carbon fiber, in accordance with an embodiment of the present disclosure. The fracture surface shows fracture Pattern Type 3, columnar vertical cracking through both ends no well-formed cons according to ASTM C39/C39M-09a.

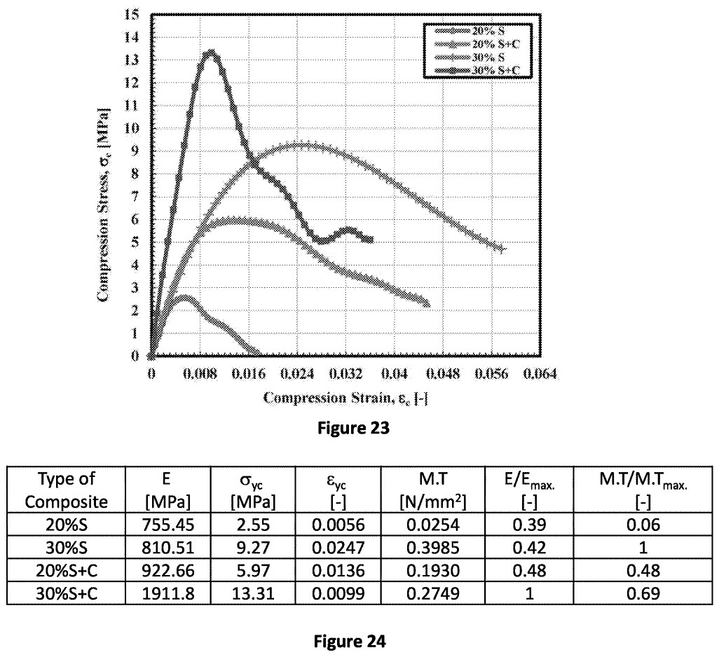

FIG. 23 illustrates engineering compression stress-strain curves for all types of composite geopolymer material with percentage 20% and 30% sodium, with and without carbon fiber, in accordance with an embodiment of the present disclosure.

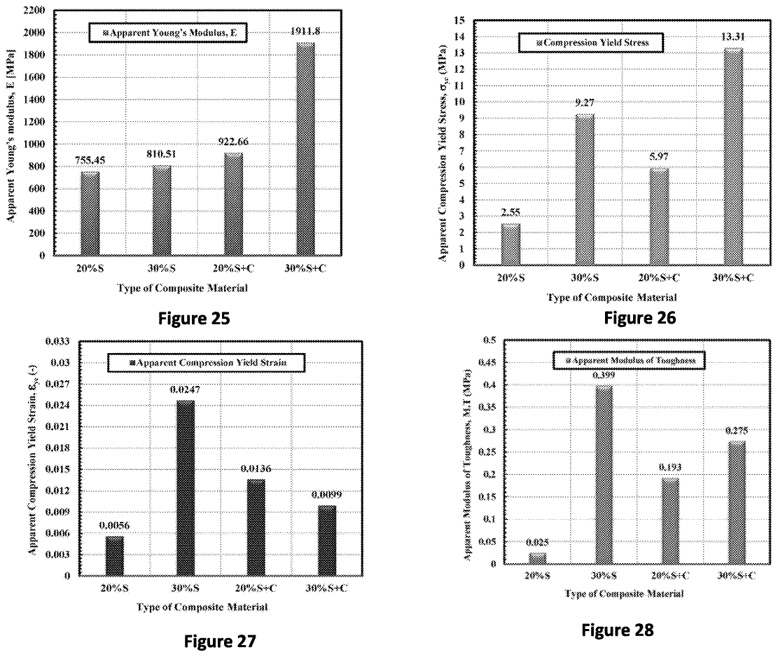

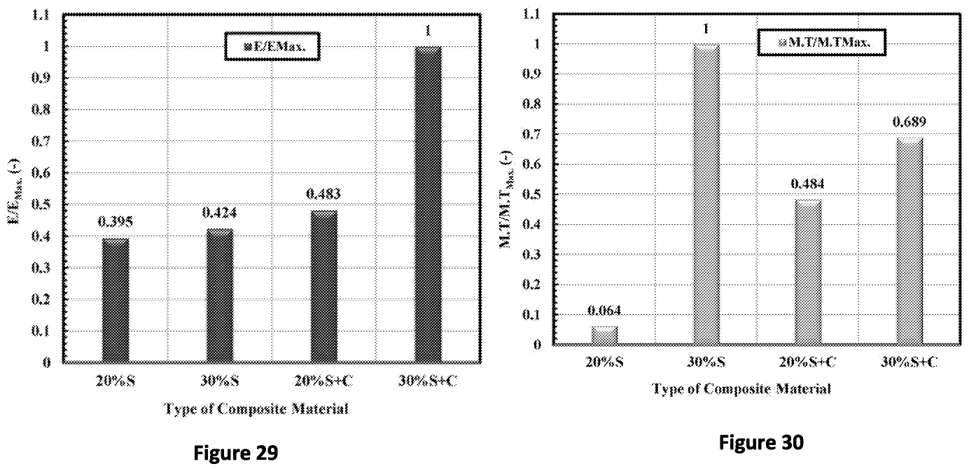

FIG. 24 illustrates a table showing the mechanical properties of four different variations of a geopolymer composite material, in accordance with an embodiment of the present disclosure. FIG. 25 illustrates a graphical representation of apparent young's modulus for all types of composite geopolymer material with percentage 20% and 30% sodium, with and without carbon fiber, in accordance with an embodiment of the present disclosure. FIG. 26 illustrate compression yield's stress for all types of composite geopolymer material with percentage 20% and 30% sodium, with and without carbon fiber, in accordance with an embodiment of the present disclosure. FIG. 27 illustrates apparent compression yield strain for all types of composite geopolymer material with percentage 20% and 30% sodium, with and without carbon fiber, in accordance with an embodiment of the present disclosure. FIG. 28 illustrates apparent modulus of toughness for all types of composite geopolymer material with percentage 20% and 30% sodium, with and without carbon fiber, in accordance with an embodiment of the present disclosure. FIG. 29 illustrates normalized stiffness (E/Emax), for all types of composite geopolymer material with percentage 20% and 30% sodium, with and without carbon fiber, in accordance with an embodiment of the present disclosure. FIG. 30 illustrates normalized toughness (MT/MTmax), for all types of composite geopolymer material with percentage 20% and 30% sodium, with and without carbon fiber, in accordance with an embodiment of the present disclosure.

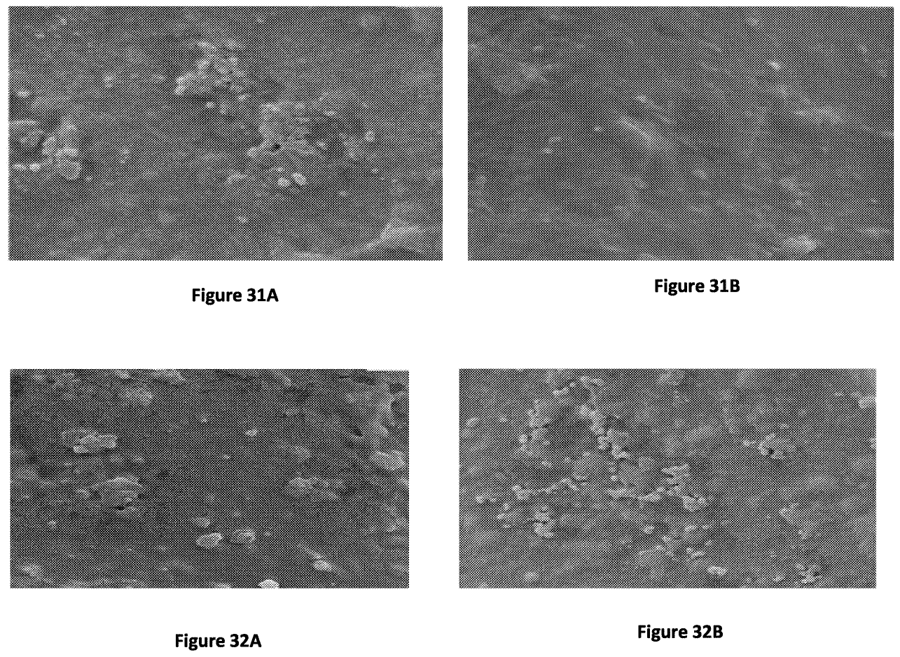

FIG. 31A illustrates SEM morphology of palm ash and 20% sodium, in accordance with an embodiment of the present disclosure. FIG. 31B illustrates SEM morphology of palm ash and 20% sodium with carbon, in accordance with an embodiment of the present disclosure.

FIG. 32A illustrates SEM morphology of palm ash and 30% sodium, in accordance with an embodiment of the present disclosure. FIG. 32B illustrates SEM morphology of palm ash and 30% sodium with carbon, in accordance with an embodiment of the present disclosure.

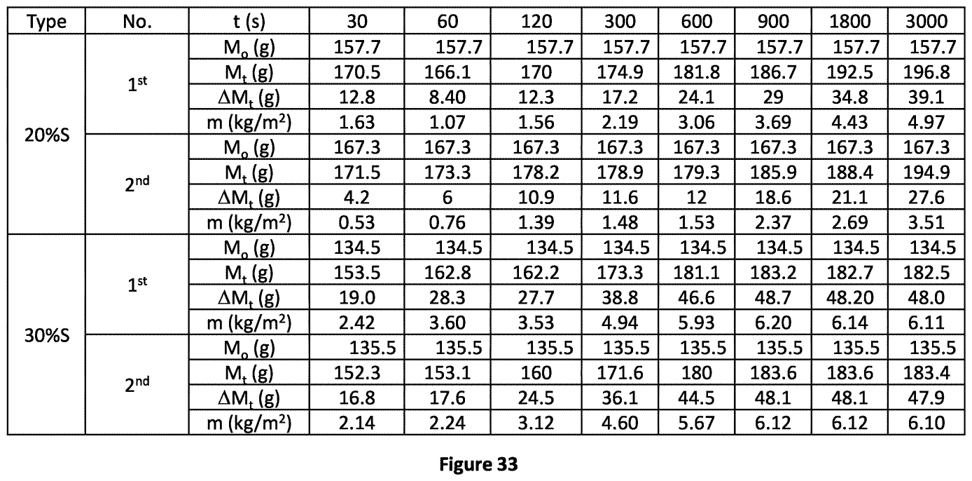

The analysis of absorption properties for geopolymer composites with the different percentages of sodium hydroxide revealed that a clear variance in the absorption properties at all percentages of sodium and absorption testing time. The absorption properties of geopolymer composites are conducted at ranging from absorption time varied from 30 to 300 (s) for both percentages. On the other hand, the absorption test is applied on two identical test specimens in each percentage to give a clear picture and higher accuracy for the absorption properties of geopolymer composites as shown in Table shown in FIG. 33, which illustrates a table showing results of absorption properties for geopolymer composites based on two different percentages of sodium hydroxide and two specimens in each absorption test, in accordance with an embodiment of the present disclosure.

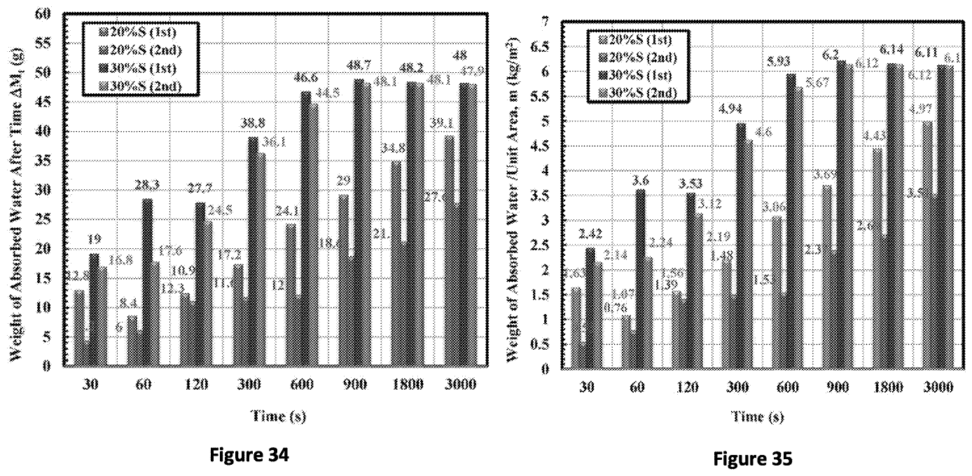

FIG. 34 illustrates weight of absorbed water versus time for geopolymer composites with two different percentages of sodium hydroxide 20% and 30% with two specimens in each percentage, in accordance with an embodiment of the present disclosure. FIG. 34 shows the weight of absorbed water, ΔMₜ versus time for geopolymer composites with two different percentages of sodium hydroxide 20% and 30% with two specimens in each percentage. The weight of absorbed water, ΔMₜ in each percentage was increased by increasing the absorption time. Whereas, in case of percentage of sodium 30% S the rate of weight of absorbed water are higher than percentage 20% S with all absorption times. This means that, the variation of percentage of sodium in the geopolymer composites plays an important and effective role on the absorption properties. On the other hand, the variation of the weight of absorbed water for specimens with sodium percentage 30 is constant approximately by value equal 48 g ranging of absorbed time from 900 to 3000 s.

FIG. 35 illustrates weight of absorbed water per unit area versus time for geopolymer composites with two different percentages of sodium hydroxide 20% and 30% with two specimens in each percentage, in accordance with an embodiment of the present disclosure. The FIG. 35 shows the weight of absorbed water per unit area versus time for geopolymer composites with two different percentages of sodium hydroxide 20% and 30% with two specimens in each percentage. The absorption results reveal that the maximum.

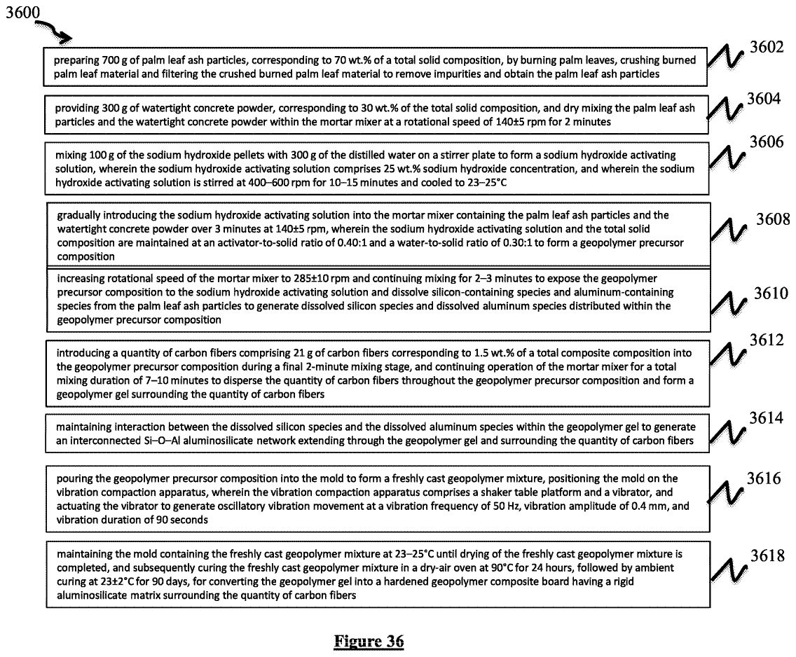

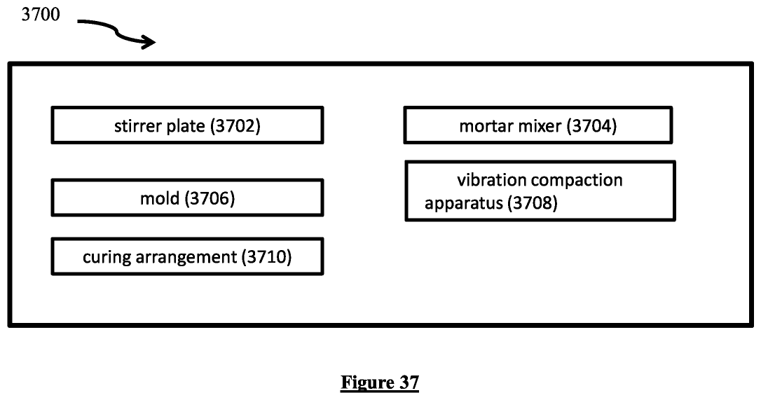

FIG. 36 illustrates a flow chart for a method for manufacturing a carbon fiber reinforced geopolymer composite board using palm leaf ash, sodium hydroxide pellets, distilled water, carbon fibers, watertight concrete powder, a mortar mixer, a mold and a vibration compaction apparatus. The method 3600 comprising:

At step 3602, the method 3600 includes preparing 700 g of palm leaf ash particles, corresponding to 70 wt. % of a total solid composition, by burning palm leaves, crushing burned palm leaf material and filtering the crushed burned palm leaf material to remove impurities and obtain the palm leaf ash particles;

At step 3604, the method 3600 includes providing 300 g of watertight concrete powder, corresponding to 30 wt. % of the total solid composition, and dry mixing the palm leaf ash particles and the watertight concrete powder within the mortar mixer at a rotational speed of 140±5 rpm for 2 minutes;

At step 3606, the method 3600 includes mixing 100 g of the sodium hydroxide pellets with 300 g of the distilled water on a stirrer plate to form a sodium hydroxide activating solution, wherein the sodium hydroxide activating solution comprises 25 wt. % sodium hydroxide concentration, and wherein the sodium hydroxide activating solution is stirred at 400-600 rpm for 10-15 minutes and cooled to 23-25 °C;

At step 3608, the method 3600 includes gradually introducing the sodium hydroxide activating solution into the mortar mixer containing the palm leaf ash particles and the watertight concrete powder over 3 minutes at 140±5 rpm, wherein the sodium hydroxide activating solution and the total solid composition are maintained at an activator-to-solid ratio of 0.40:1 and a water-to-solid ratio of 0.30:1 to form a geopolymer precursor composition;

At step 3610, the method 3600 includes increasing rotational speed of the mortar mixer to 285±10 rpm and continuing mixing for 2-3 minutes to expose the geopolymer precursor composition to the sodium hydroxide activating solution and dissolve silicon-containing species and aluminum-containing species from the palm leaf ash particles to generate dissolved silicon species and dissolved aluminum species distributed within the geopolymer precursor composition;

At step 3612, the method 3600 includes introducing a quantity of carbon fibers comprising 21 g of carbon fibers corresponding to 1.5 wt. % of a total composite composition into the geopolymer precursor composition during a final 2-minute mixing stage, and continuing operation of the mortar mixer for a total mixing duration of 7-10 minutes to disperse the quantity of carbon fibers throughout the geopolymer precursor composition and form a geopolymer gel surrounding the quantity of carbon fibers;

At step 3614, the method 3600 includes maintaining interaction between the dissolved silicon species and the dissolved aluminum species within the geopolymer gel to generate an interconnected Si—O—Al aluminosilicate network extending through the geopolymer gel and surrounding the quantity of carbon fibers;

At step 3616, the method 3600 includes pouring the geopolymer precursor composition into the mold to form a freshly cast geopolymer mixture, positioning the mold on the vibration compaction apparatus, wherein the vibration compaction apparatus comprises a shaker table platform and a vibrator, and actuating the vibrator to generate oscillatory vibration movement at a vibration frequency of 50 Hz, vibration amplitude of 0.4 mm, and vibration duration of 90 seconds, wherein the oscillatory vibration movement propagates through the mold and the freshly cast geopolymer mixture for displacement of entrapped air bubbles and redistribution of constituents throughout the freshly cast geopolymer mixture;

At step 3618, the method 3600 includes maintaining the mold containing the freshly cast geopolymer mixture at 23-25 °C until drying of the freshly cast geopolymer mixture is completed, and subsequently curing the freshly cast geopolymer mixture in a dry-air oven at 90 °C for 24 hours, followed by ambient curing at 23±2 °C for 90 days, for converting the geopolymer gel into a hardened geopolymer composite board having a rigid aluminosilicate matrix surrounding the quantity of carbon fibers.

In an embodiment, preparing the palm leaf ash particles further comprises crushing burned palm leaf material followed by subjecting the crushed burned palm leaf material to vibration-assisted filtering through the compact machine operating according to repeated vibration movement, wherein the vibration movement propagates through the crushed burned palm leaf material for separating impurity particles and non-uniform ash agglomerations from the palm leaf ash particles, and wherein vibration-assisted filtering is continued until the palm leaf ash particles introduced into the mortar mixer possess substantially uniform particulate characteristics for promoting homogeneous contact between the palm leaf ash particles and the sodium hydroxide activating solution during subsequent geopolymer precursor formation.

In an embodiment, the crushing and vibration-assisted filtering operation may function as a controlled particulate conditioning stage configured to generate palm leaf ash particles exhibiting substantially uniform physical characteristics prior to geopolymer precursor formation. Following combustion of palm leaf material, the resulting ash may contain heterogeneous constituents including incompletely burned carbonaceous fragments, fibrous residues, silica-rich clusters, large ash agglomerates, and mineral impurities originating from natural plant structures or combustion environments. Direct utilization of such heterogeneous ash material may create non-uniform reaction behavior during alkali activation because larger agglomerates and contaminant particles can obstruct interaction between reactive ash surfaces and the activating solution. Accordingly, the burned palm leaf material may initially undergo mechanical crushing through a crushing arrangement configured to reduce larger fragments into smaller particle fractions and expose previously enclosed reactive regions. Reduction of particle dimensions increases surface area availability and enhances accessibility of silica-containing and alumina-containing regions present within the ash structure.

Following crushing, the ash material may be transferred to a vibration-assisted filtering compact machine configured to generate repeated oscillatory movement for particulate classification and purification. The compact machine may include a vibration platform coupled with a filtering assembly and a vibration generating unit capable of producing repeated displacement cycles through the ash material. During operation, vibration movement propagates through the crushed material causing cyclic acceleration and redistribution of particles according to differences in particle size, density, shape factor, and mass distribution. Fine and substantially uniform ash particles migrate through filtration regions while larger agglomerates and non-reactive impurity particles remain separated. Continuous oscillatory movement further induces stratification effects in which denser particles move differently from lighter fibrous residues and oversized fragments. Such dynamic particle movement differs from static sieve separation because repeated vibration cycles maintain particle mobility and continuously expose different particle orientations to the filtering regions.

For example, where burned palm leaves generate ash containing partially combusted fibrous fragments and irregular ash clusters ranging from approximately several hundred micrometers to multiple millimeters, vibration-assisted propagation may progressively separate fine ash fractions suitable for geopolymerization from larger non-uniform materials. Repeated vibration cycles at frequencies ranging from approximately 35 Hz to 60 Hz may induce continual movement causing oversized agglomerates to remain above filtration regions while reactive fine ash particles pass through. Continued operation until substantially uniform particulate characteristics are achieved permits the palm leaf ash particles introduced into the mortar mixer to exhibit more consistent particle dimensions and surface exposure characteristics.

The resulting particulate uniformity facilitates improved interaction with the sodium hydroxide activating solution during geopolymer precursor formation. Uniform particles experience substantially similar exposure to hydroxyl ions during mixing and therefore undergo more predictable dissolution behavior. Silicon-containing species and aluminum-containing species may be released more uniformly from particle surfaces into the surrounding precursor medium, thereby reducing localized concentration variations and minimizing formation of partially reacted regions within the geopolymer precursor composition. Consequently, the subsequent geopolymerization process proceeds with improved reaction continuity and more uniform aluminosilicate network development throughout the matrix. Such particulate conditioning contributes toward reduced matrix defects, improved precursor homogeneity, enhanced interfacial bonding within the cured board structure, and more consistent structural performance throughout different board regions.

In an embodiment, preparation of the sodium hydroxide activating solution further comprises introducing 100 g of the sodium hydroxide pellets into 300 g of the distilled water while operating the stirrer plate at a rotational speed from 400 rpm to 600 rpm for 10 minutes to 15 minutes, wherein a rotating magnetic field generated by the stirrer plate produces rotational movement of a stir bar immersed within the distilled water to establish continuous circulation of the distilled water and sodium hydroxide pellets throughout a liquid volume, and wherein stirring is maintained until the sodium hydroxide pellets are dissolved throughout the distilled water to form a substantially homogeneous sodium hydroxide activating solution having a sodium hydroxide concentration of 25 wt. %, followed by maintaining the sodium hydroxide activating solution for 2 hours to 4 hours until the sodium hydroxide activating solution reaches 23 °C-25 °C prior to introduction into the mortar mixer.

The stirrer plate may include an electromagnetic drive assembly configured to generate a rotating magnetic field beneath a mixing vessel containing the sodium hydroxide pellets and distilled water. A magnetic stir bar positioned within the liquid medium may align with and respond to the rotating magnetic field, thereby producing rotational movement within the liquid volume. Continuous rotation of the stir bar establishes fluid circulation patterns including vortex formation, radial flow, and vertical recirculation movement throughout the solution volume. Such fluid motion repeatedly transports sodium hydroxide particles through changing hydrodynamic regions and concentration gradients, thereby reducing pellet accumulation and ensuring repeated contact between undissolved pellet surfaces and surrounding liquid regions. Operation within a rotational speed range of approximately 400 rpm to 600 rpm may provide sufficient mixing energy for maintaining suspension movement without producing excessive turbulence capable of causing splashing or unstable flow behavior.

As dissolution proceeds, sodium hydroxide pellets progressively separate into sodium ions and hydroxyl ions distributed throughout the liquid medium. Hydroxyl ions may increase alkalinity of the activating solution and establish a chemically reactive environment intended for subsequent interaction with silica-containing and alumina-containing constituents within the palm leaf ash particles. Continued circulation movement throughout the 10-minute to 15-minute mixing duration permits concentration equalization across the liquid volume and minimizes development of concentration gradients that could otherwise create inconsistent precursor behavior. Formation of a substantially homogeneous activating solution enables the alkaline medium to exhibit uniform chemical characteristics throughout the solution body prior to introduction into the mortar mixer.

Following dissolution, the sodium hydroxide activating solution may be maintained under static conditions for approximately 2 hours to 4 hours until temperature reduction occurs and the solution reaches approximately 23 °C-25 °C. This stabilization interval may perform multiple functions beyond simple cooling. Since dissolution of sodium hydroxide generates heat, immediate introduction of a thermally elevated solution into the mortar mixer may accelerate localized reaction rates and induce premature geopolymer gel formation at isolated regions of the precursor composition. Excessive temperature during precursor preparation may additionally increase viscosity changes and reduce process consistency. Maintaining the solution within the specified temperature range therefore permits controlled initiation of geopolymer reactions during later mixing stages.

For example, if freshly prepared sodium hydroxide solution at temperatures exceeding approximately 40 °C is directly introduced into palm leaf ash and watertight concrete powder, regions immediately adjacent to the activator contact points may undergo rapid silica dissolution and premature gel development, thereby generating localized matrix heterogeneity. In contrast, a cooled and stabilized activating solution introduced at approximately room temperature permits gradual and substantially uniform exposure of palm leaf ash particles to hydroxyl ions throughout the precursor composition. Such controlled activation conditions enable more consistent dissolution of silicon-containing species and aluminum-containing species, facilitate homogeneous geopolymer precursor development, reduce localized reaction irregularities, and contribute toward formation of a more uniform aluminosilicate matrix structure within the subsequently cured geopolymer composite board.

In an embodiment, formation of the geopolymer precursor composition further comprises operating the mortar mixer according to a sequential multi-stage mixing operation including a first dry mixing stage performed at 140±5 rpm for 2 minutes for distributing 700 g of the palm leaf ash particles and 300 g of the watertight concrete powder, followed by a second mixing stage including gradual addition of the sodium hydroxide activating solution over 3 minutes while maintaining rotational movement at 140±5 rpm, and thereafter increasing rotational speed of the mortar mixer to 285±10 rpm for 2 minutes to 3 minutes, wherein continued rotational mixing establishes repeated contact between the sodium hydroxide activating solution and the palm leaf ash particles for promoting dissolution of silicon-containing species and aluminum-containing species into the geopolymer precursor composition, and wherein continued operation of the mortar mixer subjects the geopolymer precursor composition to an activator-to-solid ratio of 0.40:1 and a water-to-solid ratio of 0.30:1, wherein the sodium hydroxide activating solution remains distributed throughout the geopolymer precursor composition during the rotational mixing operation for maintaining dissolution of reactive constituents from the palm leaf ash particles and generating dissolved silicon-containing species and dissolved aluminum-containing species distributed throughout the geopolymer precursor composition prior to geopolymer gel formation. Rather than functioning solely as a blending operation, the mortar mixer may create changing mechanical and chemical environments at different stages of rotational operation to regulate particle distribution, activator exposure, dissolution kinetics, and precursor development. The staged processing sequence permits gradual transition from particulate redistribution to chemical activation and ultimately to precursor generation suitable for geopolymer network formation.

During the first dry mixing stage performed at approximately 140±5 rpm for 2 minutes, the palm leaf ash particles and watertight concrete powder may undergo repeated circulation and redistribution through rotational movement generated within the mortar mixer chamber. The palm leaf ash particles may provide reactive silica-containing and alumina-containing constituents required for geopolymer formation, while the watertight concrete powder may contribute supplementary mineral phases and matrix densification characteristics. Rotational movement during the dry stage repeatedly transports particle clusters through changing positions within the mixer cavity and disrupts localized accumulations that may otherwise generate composition non-uniformity. Mechanical interaction among particles further improves contact between different constituent fractions and creates a substantially homogeneous dry mixture before activator exposure. Uniform dry distribution may be particularly beneficial because non-uniform constituent arrangements can subsequently create isolated reaction zones and incomplete matrix development.

Following dry homogenization, the sodium hydroxide activating solution may be gradually introduced over approximately three minutes while maintaining mixer operation at the initial rotational speed. Controlled introduction of the activating solution avoids abrupt liquid accumulation and permits progressive wetting of particulate surfaces. As the alkaline solution contacts palm leaf ash particles, hydroxyl ions begin penetrating exposed particle regions and initiate surface destabilization processes affecting silicon-containing and aluminum-containing structures. Gradual liquid introduction enables repeated exposure cycles in which particles encounter the activating solution under changing circulation conditions. The activator-to-solid ratio of approximately 0.40:1 and water-to-solid ratio of approximately 0.30:1 may establish a controlled balance between fluid mobility and chemical reactivity. If activator content becomes excessively low, insufficient ion availability may reduce dissolution efficiency, whereas excessive liquid content may increase porosity and alter precursor consistency. Controlled ratio maintenance therefore permits sufficient particle exposure while preserving workable precursor characteristics.

After initial wetting and activator incorporation, the mortar mixer rotational speed may be increased to approximately 285±10 rpm for an additional period of approximately 2-3 minutes. Increased rotational velocity introduces greater shear forces and circulation intensity within the developing precursor composition. Enhanced movement repeatedly transports particle surfaces into contact with hydroxyl-rich regions and promotes continuous exchange between dissolved species and surrounding liquid phases. Under these conditions, silicon-containing species and aluminum-containing species progressively migrate from palm leaf ash surfaces into the liquid-filled precursor regions. Dissolution may initially occur at particle surface boundaries and gradually expand inward as reactive sites become exposed. Continued circulation movement may additionally prevent localized depletion of hydroxyl ions around individual particles and maintain ongoing dissolution behavior throughout the precursor volume.

For example, if an alkaline solution is introduced instantaneously and mixed at elevated speed without sequential processing, portions of the precursor composition may experience excessive localized activator concentration while other regions remain insufficiently activated. Such conditions may generate partially reacted zones, heterogeneous viscosity development, and irregular geopolymer network formation. In contrast, the sequential mixing process permits gradual activation and repeated circulation of particles throughout changing reaction environments. Dissolved silicon-containing species and dissolved aluminum-containing species become more uniformly distributed through the precursor composition before significant gel development occurs.

As dissolution progresses, increasing concentrations of reactive species become suspended within the liquid phase and initiate formation of precursor oligomer structures that later contribute toward geopolymer gel development. Because the sodium hydroxide activating solution remains substantially distributed throughout the precursor during continued rotational movement, reactive species generation may proceed throughout the composition rather than becoming restricted to isolated regions. Such controlled precursor formation contributes toward improved chemical uniformity, more predictable geopolymer reaction progression, reduced occurrence of unreacted particle regions, and enhanced continuity of the subsequently generated aluminosilicate matrix extending throughout the cured geopolymer composite board.

In an embodiment, introducing the quantity of carbon fibers further comprises gradually introducing 21 g of chopped carbon fibers corresponding to 1.5 wt. % of total composite composition during a final 2-minute mixing stage of the mortar mixer while maintaining rotational movement of the geopolymer precursor composition, wherein the carbon fibers comprise a fiber length from 6 mm to 12 mm, and wherein gradual introduction of the carbon fibers during rotational movement distributes the carbon fibers through interstitial regions of the geopolymer precursor composition and establishes reinforcement regions extending through the geopolymer precursor composition, and wherein continued mixing of the geopolymer precursor composition after introducing the carbon fibers is maintained for a total mixing duration from 7 minutes to 10 minutes, wherein dissolved silicon-containing species and dissolved aluminum-containing species interact within the geopolymer precursor composition to initiate geopolymer gel formation around the carbon fibers and between adjacent carbon fibers, and wherein continued interaction between the dissolved silicon-containing species and dissolved aluminum-containing species forms interconnected Si—O—Al bonds extending through the geopolymer gel and surrounding the carbon fibers to establish an aluminosilicate network extending through the geopolymer precursor composition.

During the final approximately two-minute mixing stage of the mortar mixer, about 21 g of chopped carbon fibers corresponding to approximately 1.5 wt. % of the total composite composition may be introduced gradually while maintaining continued rotational movement of the geopolymer precursor composition. Gradual addition may prevent formation of fiber accumulation regions and reduce occurrence of fiber entanglement phenomena frequently associated with simultaneous bulk addition of reinforcement materials. Carbon fibers introduced in successive portions become progressively incorporated into moving precursor regions and experience repeated circulation throughout changing flow trajectories generated within the mortar mixer. Such controlled introduction may improve dispersion behavior and permit individual fibers to occupy separated regions within the precursor body rather than aggregating into localized clusters.

The carbon fibers may comprise fiber lengths ranging from approximately 6 mm to 12 mm selected to provide a balance between reinforcement continuity and precursor processability. Fibers shorter than the lower range may provide insufficient crack-bridging capability due to limited embedded length within the matrix, whereas fibers substantially exceeding the upper range may increase the probability of fiber entanglement and reduce uniform distribution characteristics during mixing. Fibers within the disclosed range may migrate into interstitial regions located between precursor material portions and become suspended throughout liquid-filled and particulate-containing regions of the geopolymer precursor composition. Rotational movement generated within the mortar mixer continuously repositions individual fibers and exposes them to varying local flow conditions, thereby creating distributed reinforcement pathways extending through different regions of the precursor body.

Continued operation of the mortar mixer for a total duration ranging from approximately 7 minutes to 10 minutes after fiber introduction permits simultaneous reinforcement distribution and precursor reaction progression. During this period, dissolved silicon-containing species and dissolved aluminum-containing species previously released from palm leaf ash particles remain suspended throughout the precursor medium and continue interacting under alkaline conditions. As concentration levels of dissolved reactive species increase, condensation reactions may initiate formation of geopolymer precursor oligomers and gel regions. Geopolymer gel formation may progressively occur around exposed carbon fiber surfaces and within matrix regions positioned between neighboring fibers.

Formation of geopolymer gel around the carbon fibers may create developing matrix-fiber interface regions that later contribute to reinforcement anchoring behavior following curing. Such interface regions may establish mechanical interlocking and load transfer pathways between the rigid geopolymer matrix and embedded fibers. Continued interaction among dissolved silicon-containing species and dissolved aluminum-containing species may progressively generate interconnected Si—O—Al bonds extending through the developing gel regions. As these reactions continue, the gel structures surrounding individual fibers and matrix regions between adjacent fibers become interconnected and establish a substantially continuous aluminosilicate network extending throughout the geopolymer precursor composition.

For example, if carbon fibers are introduced immediately at the onset of precursor preparation before adequate dissolution of reactive species occurs, portions of the precursor may exhibit non-uniform reinforcement distribution and reduced matrix continuity around embedded fibers. Fiber clusters may develop and isolated matrix regions may remain insufficiently reinforced. Conversely, gradual fiber introduction during later stages of precursor preparation permits fibers to become distributed within an already activated precursor medium containing dissolved reactive species. As geopolymer gel subsequently develops, surrounding matrix regions progressively encapsulate and anchor individual fibers throughout the precursor body.

As curing later converts geopolymer gel regions into a rigid aluminosilicate matrix, the previously established fiber distribution and matrix-fiber interface structures may contribute toward improved stress transfer characteristics, enhanced crack interruption behavior, and reduced concentration of localized structural weaknesses. Distributed carbon fibers extending through multiple matrix regions may further promote gradual redistribution of mechanical stresses during loading and improve continuity of reinforcement throughout the cured geopolymer composite board.

In an embodiment, positioning the mold on the vibration compaction apparatus further comprises placing the mold containing the freshly cast geopolymer mixture on the shaker table and actuating vibration movement at a frequency ranging from 40 Hz to 60 Hz, a vibration amplitude ranging from 0.3 mm to 0.5 mm, and a vibration duration ranging from 60 seconds to 120 seconds, including operation at 50 Hz, 0.4 mm amplitude, and 90 seconds, wherein vibration movement propagates through the mold and through the freshly cast geopolymer mixture for displacement of entrapped air bubbles from internal regions of the freshly cast geopolymer mixture toward exposed surfaces of the freshly cast geopolymer mixture while simultaneously redistributing geopolymer constituents throughout the mold, and wherein continued vibration movement through the freshly cast geopolymer mixture is maintained until internal density variation within the freshly cast geopolymer mixture is reduced and geopolymer constituents become substantially uniformly distributed through the mold cavity such that subsequent drying and curing operations convert the geopolymer gel into a hardened geopolymer composite board containing a rigid aluminosilicate matrix surrounding the carbon fibers.

In an embodiment, the vibration compaction stage may function as a controlled densification and constituent redistribution process configured to improve internal structural uniformity of the freshly cast geopolymer mixture prior to curing. Following discharge of the geopolymer precursor composition into the mold cavity, the freshly cast mixture may contain localized air pockets, non-uniform constituent distributions, and regions exhibiting variations in particulate packing density resulting from precursor flow behavior during casting. Such conditions may create internal discontinuities capable of producing porosity, localized weakness regions, and inconsistent matrix formation following curing. Accordingly, the mold containing the freshly cast geopolymer mixture may be positioned on a shaker table forming part of a vibration compaction apparatus configured to generate controlled oscillatory movement through the mold structure and the precursor material contained therein.

The vibration compaction apparatus may include a shaker platform mechanically coupled with a vibration-generating assembly capable of producing repeated displacement cycles at frequencies ranging from approximately 40 Hz to 60 Hz and vibration amplitudes ranging from approximately 0.3 mm to 0.5 mm. During operation, cyclic mechanical movement generated by the vibration source propagates through lower mold regions, sidewall regions, and central mold regions into the freshly cast geopolymer mixture. Such oscillatory propagation produces repeated acceleration and deceleration cycles within the precursor body, causing suspended particles, liquid-filled regions, and entrapped gaseous regions to undergo continuous movement. The specified vibration duration ranging from approximately 60 seconds to 120 seconds, including a representative operating condition of 50 Hz, 0.4 mm amplitude, and 90 seconds, may establish sufficient propagation time for internal material redistribution while avoiding excessive segregation of constituents.

As vibration energy propagates through the geopolymer mixture, entrapped air bubbles positioned within internal regions may experience buoyancy-assisted migration toward exposed upper surfaces. Repeated oscillatory movement reduces adhesive resistance between air pockets and surrounding matrix constituents, permitting movement of gaseous inclusions through interconnected liquid regions toward external surfaces where release may occur. Simultaneously, particulate constituents including palm leaf ash particles, watertight concrete constituents, dissolved precursor species, and dispersed carbon fibers undergo transient movement in response to changing inertial forces generated during vibration cycles. Such movement permits localized constituent rearrangement and progressive reduction of concentration gradients within different mold regions.

For example, during initial mold filling, heavier particulate regions may settle toward lower mold areas while lighter constituents and localized air-containing regions remain distributed non-uniformly throughout the precursor volume. In the absence of vibration-assisted compaction, such localized variations may remain preserved after curing and generate internal density inconsistencies across board thickness regions. Under controlled vibration conditions, repeated propagation through the mold may permit lower-density regions and concentrated material regions to progressively redistribute toward more balanced spatial arrangements. Carbon fibers suspended within the precursor composition may additionally undergo slight positional adjustments and become more uniformly distributed through matrix regions rather than remaining concentrated within isolated zones.

The vibration amplitude may further influence constituent mobility within the freshly cast mixture. Lower amplitudes may provide insufficient internal movement for effective air displacement, whereas excessively large amplitudes could potentially produce constituent separation or disruption of developing precursor continuity. Similarly, vibration duration may be selected to permit adequate redistribution without inducing segregation of suspended materials. The specified operating parameters therefore maintain controlled movement sufficient to facilitate internal structural equalization throughout the precursor body.

Continued vibration movement through lower, central, and upper regions of the mold cavity progressively reduces density variation throughout the freshly cast geopolymer mixture. Such redistribution creates a more homogeneous internal arrangement prior to subsequent drying and curing operations. As curing later converts geopolymer gel regions into a rigid aluminosilicate matrix surrounding the carbon fibers, the previously established internal uniformity contributes toward improved matrix continuity, reduced void formation, minimized localized stress concentration regions, and enhanced consistency of structural characteristics throughout the cured geopolymer composite board.

In an embodiment, curing of the freshly cast geopolymer mixture comprises maintaining the mold at 23 °C-25 °C until drying of the freshly cast geopolymer mixture is completed, removing the geopolymer composite board from the mold, curing the geopolymer composite board in a dry-air oven at 90 °C for 24 hours, and maintaining ambient curing at 23±2 °C for 90 days, wherein continued curing converts the geopolymer gel into a rigid aluminosilicate matrix surrounding the carbon fibers and extending throughout the geopolymer composite board.

Following completion of vibration compaction, the mold containing the freshly cast geopolymer mixture may initially be maintained under laboratory ambient conditions at approximately 23 °C-25 °C until drying of the freshly cast geopolymer mixture is substantially completed. During this preliminary conditioning stage, residual free moisture located within surface and near-surface regions of the precursor composition may undergo gradual evaporation while the freshly cast material experiences initial structural stabilization. Controlled room-temperature exposure may permit reduction of excessive moisture content without introducing abrupt thermal gradients capable of generating localized shrinkage or surface defects. During this period, partially dissolved silicon-containing species and aluminum-containing species may continue undergoing early-stage interactions within liquid-filled regions, thereby promoting gradual precursor development prior to thermal curing.

Maintenance within the mold during the initial drying period may additionally preserve dimensional stability of the precursor composition while geopolymer gel regions begin acquiring sufficient structural integrity. Premature demolding before adequate initial stabilization may increase susceptibility to deformation, edge cracking, or localized structural disturbances because the geopolymer matrix may remain insufficiently developed to withstand handling forces. Accordingly, controlled ambient retention within the mold may permit progressive strengthening before transfer into subsequent curing stages.

Following completion of preliminary drying, the geopolymer composite board may be removed from the mold and transferred into a dry-air oven configured to maintain a temperature of approximately 90 °C for approximately 24 hours. Exposure to elevated temperature conditions may increase mobility of dissolved reactive species and accelerate condensation reactions occurring within geopolymer gel regions. Thermal energy supplied during oven curing may facilitate continued interactions between dissolved silicon-containing species and dissolved aluminum-containing species, thereby increasing formation of interconnected Si—O—Al linkages and promoting extension of geopolymer chain structures throughout the matrix. Simultaneously, controlled heat exposure may remove residual moisture retained within internal regions and reduce the likelihood of moisture entrapment within subsequently hardened structures.

For example, when geopolymer precursor materials are subjected only to ambient drying without elevated temperature treatment, geopolymer reactions may proceed at slower rates and localized regions containing partially reacted species may remain within the matrix. Such incomplete reaction progression can contribute to heterogeneous matrix development and reduced structural continuity. By contrast, controlled dry-air curing at approximately 90 °C may accelerate precursor transformation and facilitate more uniform network development throughout the board structure.

After completion of oven curing, the geopolymer composite board may undergo prolonged ambient curing at approximately 23±2 °C for a duration of approximately 90 days. This extended conditioning period may permit continuation of slower geopolymer reaction pathways not completed during elevated-temperature exposure. Residual dissolved species and incompletely reacted gel regions may continue participating in progressive condensation and crosslinking reactions over extended periods. Additional aluminosilicate chain formation and network interconnection may therefore occur throughout the matrix, resulting in increased structural continuity and maturation of the geopolymer architecture.

During prolonged curing, geopolymer gel regions surrounding the carbon fibers may progressively convert into a rigid aluminosilicate matrix extending around exposed fiber surfaces and throughout adjacent matrix regions. Interface regions previously established around embedded carbon fibers may become increasingly consolidated and form anchoring structures capable of improving matrix-fiber interaction. Such progressive network development may contribute to stronger reinforcement integration and more uniform stress transfer characteristics throughout the composite structure.

In an embodiment, dissolution of silicon-containing species and aluminum-containing species from the palm leaf ash particles comprises maintaining continued contact between the sodium hydroxide activating solution and the palm leaf ash particles during operation of the mortar mixer such that alkaline exposure progressively dissolves surface regions of the palm leaf ash particles and forms dissolved silicon-containing species and dissolved aluminum-containing species distributed through the geopolymer precursor composition, and wherein the dissolved silicon-containing species and dissolved aluminum-containing species undergo migration through liquid-filled regions of the geopolymer precursor composition during the total mixing duration of 7 minutes to 10 minutes prior to geopolymer gel formation, and wherein continued operation of the mortar mixer at 285±10 rpm following introduction of the sodium hydroxide activating solution subjects the geopolymer precursor composition to repeated circulation movement causing the dissolved silicon-containing species and dissolved aluminum-containing species to occupy regions surrounding the quantity of carbon fibers, wherein geopolymer gel formation is initiated simultaneously at carbon-fiber adjacent regions and matrix regions positioned between adjacent carbon fibers for forming interconnected reaction regions extending through the geopolymer precursor composition.

Palm leaf ash particles may contain silica-containing and alumina-containing phases embedded within complex inorganic structures produced during combustion of palm leaf biomass. These structures may initially exist as relatively stable networks in which silicon and aluminum species remain bound within oxygen-linked frameworks. Upon introduction of the sodium hydroxide activating solution, hydroxyl ions present within the alkaline medium may repeatedly contact exposed particle surfaces and begin destabilizing surface bonds through alkaline attack mechanisms. Initial dissolution may occur at highly reactive surface sites including microcracks, surface irregularities, and exposed mineral boundaries. As exposure continues, outer particle layers progressively undergo dissolution and release silicon-containing species and aluminum-containing species into surrounding liquid-filled regions of the geopolymer precursor composition.

Continued operation of the mortar mixer throughout the total mixing duration of approximately 7 minutes to 10 minutes may establish repeated circulation movement within the precursor composition. Rotational movement generated at approximately 285±10 rpm may create dynamic flow pathways characterized by radial circulation, localized shear movement, and repeated constituent displacement throughout the mixer cavity. Such movement repeatedly transports dissolved reactive species away from particle surfaces and continuously exposes fresh regions of the palm leaf ash particles to hydroxyl-rich liquid regions. Removal of dissolved species from particle interfaces may reduce local saturation conditions and permit continued extraction of additional reactive constituents from underlying particle regions.

The dissolved silicon-containing species and dissolved aluminum-containing species generated during alkaline exposure may thereafter migrate through interconnected liquid-filled regions distributed throughout the geopolymer precursor composition. Migration behavior may occur through concentration-driven movement and circulation-assisted transport mechanisms generated during rotational mixing. Unlike static reaction environments where dissolved species remain localized near dissolution regions, repeated circulation movement within the mortar mixer may continuously redistribute dissolved constituents throughout the precursor volume. Consequently, reactive species generated at one region of the precursor composition may be transported toward spatially separate regions containing suspended carbon fibers and developing matrix structures.

For example, silicon-containing species released from palm leaf ash particles initially positioned near lower regions of the mortar mixer may subsequently migrate toward upper or central precursor regions through circulation pathways established during continued rotational movement. Similarly, dissolved aluminum-containing species originating from different particle locations may become redistributed throughout surrounding liquid regions and transported toward reinforcement-containing portions of the precursor composition. Such movement facilitates uniform availability of reactive species throughout the precursor volume and minimizes localized depletion or concentration imbalance conditions.

As continued mixing progresses, dissolved silicon-containing species and dissolved aluminum-containing species may increasingly occupy regions adjacent to the carbon fibers introduced into the precursor composition. Carbon fibers distributed throughout interstitial matrix regions may therefore become surrounded by precursor liquid regions containing reactive species capable of participating in subsequent geopolymerization processes. Geopolymer gel formation may initiate simultaneously at matrix regions positioned between adjacent fibers and at regions immediately surrounding exposed carbon fiber surfaces. Initial gel development may occur through condensation and association reactions involving dissolved precursor species, resulting in formation of localized geopolymer nuclei distributed throughout the precursor composition.

As gel formation continues, neighboring reaction regions surrounding individual fibers and matrix portions positioned between adjacent fibers may progressively expand and interconnect. These interconnected reaction regions may ultimately establish continuous pathways extending through the geopolymer precursor composition and surrounding distributed carbon fibers. For example, reaction zones initially generated around separate carbon fibers positioned within neighboring precursor regions may eventually merge into larger interconnected structures extending across multiple reinforcement regions. Such reaction continuity permits progressive establishment of a developing aluminosilicate network capable of surrounding reinforcement structures and extending throughout the precursor body.

Consequently, controlled dissolution and migration of reactive species during continued mortar mixer operation contributes toward more uniform geopolymer precursor development, improved matrix continuity surrounding reinforcement elements, enhanced reaction distribution throughout the precursor composition, and more effective integration of carbon fibers within the subsequently formed rigid geopolymer matrix.

In an embodiment, introducing the quantity of carbon fibers further comprises gradually introducing the quantity of carbon fibers during the final 2-minute mixing stage in a progressive addition sequence while maintaining rotational movement of the mortar mixer, wherein the quantity of carbon fibers enters the geopolymer precursor composition in successive portions distributed over the final mixing stage for reducing carbon-fiber accumulation regions and establishing substantially uniform carbon-fiber spacing through the geopolymer precursor composition, and wherein the quantity of carbon fibers comprises chopped carbon fibers having a fiber length from 6 mm to 12 mm, and wherein continued rotational movement of the geopolymer precursor composition positions individual carbon fibers through interstitial regions located between geopolymer precursor material portions such that geopolymer gel formation occupies regions surrounding individual carbon fibers and forms embedded crack-bridging reinforcement regions extending through a board thickness direction.

In an embodiment, incorporation of the carbon fibers may be performed according to a progressive reinforcement distribution process configured to establish substantially uniform spatial positioning of reinforcement structures throughout the geopolymer precursor composition prior to curing. Rather than introducing the entire quantity of carbon fibers simultaneously into the mortar mixer, the fibers may be supplied in successive portions during the final mixing stage so that reinforcement integration occurs gradually while precursor movement is continuously maintained. Progressive addition may function as a controlled dispersion mechanism intended to minimize formation of localized fiber-rich regions and facilitate uniform interaction between the carbon fibers and the developing geopolymer precursor composition.

During operation of the mortar mixer, rotational movement generated within the precursor composition may create continuous circulation pathways involving radial flow, shear-induced movement, and repeated displacement of particulate and liquid phases throughout the mixing chamber. Under such conditions, the carbon fibers may be introduced incrementally over the final approximately two-minute mixing period in multiple portions distributed over time rather than through a single addition event. Successive introduction of fiber portions permits previously introduced fibers to become dispersed and incorporated within moving precursor regions before additional fibers enter the system. Such staged integration reduces probability of fiber accumulation and decreases the likelihood that neighboring fibers enter the precursor composition as compact clusters.

Localized carbon-fiber accumulation regions may otherwise create reinforcement non-uniformities and matrix discontinuities because excessive fiber concentration in isolated areas may interfere with precursor flow and restrict complete geopolymer penetration between adjacent fibers. By progressively introducing the carbon fibers, rotational movement within the mortar mixer repeatedly transports fibers away from entry regions and distributes them throughout different precursor zones. Consequently, substantially uniform carbon-fiber spacing may be established across lower, central, and upper portions of the geopolymer precursor composition. Uniform spacing of reinforcement elements contributes toward more consistent distribution of mechanical reinforcement pathways throughout the resulting composite board.

The carbon fibers may comprise chopped fibers having lengths ranging from approximately 6 mm to 12 mm. Fibers within this range may possess dimensions sufficient for extending across multiple matrix regions while remaining capable of movement through interstitial precursor spaces generated between particulate and liquid regions of the geopolymer composition. Continued rotational movement of the precursor composition may position individual fibers within spaces located between precursor material portions and developing geopolymer regions. During circulation movement, fibers may experience changing orientations caused by localized shear conditions and movement trajectories generated within the mortar mixer. As a result, the fibers may become positioned according to partially random and distributed orientations extending through different portions of the precursor body.

As dissolved silicon-containing species and dissolved aluminum-containing species continue interacting within the precursor composition, geopolymer gel formation may progressively occur around the positioned fibers. Developing gel structures may occupy regions surrounding exposed carbon fiber surfaces and gradually establish matrix-fiber interface zones. Because individual fibers become positioned throughout interstitial precursor regions, geopolymer gel development may occur around substantially separated reinforcement elements rather than surrounding isolated fiber clusters. Such gel formation progressively secures individual fibers within surrounding matrix material and establishes embedded reinforcement pathways extending through the precursor composition.

For example, if the entire quantity of chopped carbon fibers is introduced simultaneously into the precursor mixture, fiber entanglement and localized bundle formation may occur near the addition region, producing isolated reinforcement zones and neighboring matrix regions substantially lacking reinforcement coverage. Such irregularity may generate inconsistent load transfer behavior and localized structural deficiencies after curing. In contrast, progressive addition permits distributed incorporation of fibers throughout the precursor volume and promotes formation of more uniform reinforcement architectures.

As geopolymerization continues and curing subsequently converts gel structures into a rigid aluminosilicate matrix, the embedded fibers may form crack-bridging reinforcement regions extending through the board thickness direction. During mechanical loading conditions, microcracks generated within matrix regions may encounter fibers extending across developing fracture pathways. Embedded fibers positioned throughout the board thickness may therefore function as internal bridging structures capable of redistributing stress concentrations and interrupting crack extension pathways. Distribution of reinforcement regions across multiple thickness portions contributes toward improved continuity of structural support and more uniform reinforcement behavior throughout the completed geopolymer composite board.

In an embodiment, generation of the interconnected Si—O—Al aluminosilicate network comprises continued interaction between the dissolved silicon-containing species and dissolved aluminum-containing species following carbon fiber introduction, wherein the interconnected Si—O—Al aluminosilicate network propagates through geopolymer gel regions positioned around the quantity of carbon fibers and between adjacent geopolymer gel regions to establish a three-dimensional aluminosilicate network extending continuously throughout the geopolymer precursor composition, and wherein formation of the interconnected Si—O—Al aluminosilicate network comprises progressive geopolymerization stages including dissolution of reactive species from the palm leaf ash particles, geopolymer gel generation, network growth around the quantity of carbon fibers and conversion of the geopolymer gel into a rigid aluminosilicate matrix during the curing operation, wherein the progressive geopolymerization stages occur sequentially throughout the curing duration.

In an embodiment, generation of the interconnected Si—O—Al aluminosilicate network may comprise a progressive and spatially distributed geopolymerization process occurring after introduction of the carbon fibers and continuing throughout the curing duration until formation of a substantially rigid matrix structure extending throughout the geopolymer composite board. The interconnected network formation process may transform dissolved reactive constituents generated from palm leaf ash into a three-dimensional structural framework capable of surrounding reinforcement elements and interconnecting different matrix regions. Rather than occurring as a single-stage reaction, formation of the aluminosilicate network may proceed through sequential reaction mechanisms involving dissolution, precursor interaction, gel development, network propagation, and matrix consolidation.

Following alkaline dissolution of palm leaf ash particles during precursor preparation, dissolved silicon-containing species and dissolved aluminum-containing species may remain distributed throughout liquid-filled regions of the geopolymer precursor composition. These dissolved species may exist as chemically active molecular or oligomeric entities capable of undergoing subsequent association and condensation reactions under alkaline conditions. Continued rotational movement and precursor circulation maintain contact among reactive species and facilitate repeated interaction events throughout the precursor volume. After introduction of the carbon fibers, reactive species distributed within surrounding precursor regions may continue migrating toward both matrix regions and fiber-adjacent regions, thereby establishing conditions suitable for simultaneous geopolymer development across multiple locations.

As concentrations of dissolved reactive species progressively increase, geopolymer gel generation may begin through formation of early-stage aluminosilicate precursor structures. Initially, smaller reaction clusters may form through association of silicon-containing species and aluminum-containing species linked by oxygen bridges. These localized reaction clusters may subsequently combine and expand into geopolymer gel regions occupying precursor spaces positioned between particulate constituents and surrounding embedded carbon fibers. Unlike isolated reaction zones, the developing gel structures may emerge simultaneously at fiber-adjacent regions and within matrix portions positioned between neighboring fibers. Such distributed initiation permits reaction progression throughout substantially the entire precursor composition rather than restricting geopolymer formation to isolated locations.

As geopolymer gel regions continue developing, interconnected Si—O—Al bonds may progressively form through repeated condensation reactions occurring among neighboring reactive species and gel structures. Expansion of these linkages may permit the developing aluminosilicate network to propagate through matrix regions and around the quantity of carbon fibers. Carbon fibers positioned throughout the precursor body may therefore become progressively surrounded by growing geopolymer structures, resulting in establishment of matrix-fiber interface regions integrated within the developing network architecture. The geopolymer gel occupying spaces between neighboring fibers may simultaneously continue expansion and merge with surrounding gel structures.

For example, individual carbon fibers distributed through lower, central, and upper regions of the precursor composition may initially become surrounded by localized gel regions generated through reaction of dissolved species present within adjacent liquid-filled spaces. As additional geopolymer reactions occur, neighboring gel regions surrounding separate fibers may gradually expand and merge with matrix gel regions positioned between the fibers. Continued network growth may therefore create interconnected reaction pathways extending across multiple reinforcement-containing regions and throughout the precursor body.

Formation of the interconnected Si—O—Al aluminosilicate network may further involve sequential geopolymerization stages occurring throughout the curing operation. During an initial stage, continued alkaline exposure may permit ongoing dissolution of residual reactive constituents from palm leaf ash particles that remain partially unreacted during mixing operations. Subsequently, geopolymer gel regions generated from dissolved species may undergo expansion and increased interconnection. Intermediate stages may involve progressive network growth around embedded carbon fibers and continued formation of aluminosilicate chains extending through matrix regions. As curing proceeds, these chain structures may undergo additional crosslinking and interconnection reactions, thereby generating increasingly complex three-dimensional network architectures.

During elevated temperature curing and subsequent ambient conditioning, geopolymer gel structures may progressively convert into a rigid aluminosilicate matrix extending continuously throughout the composite board. Water removal, continued condensation reactions, and network densification may collectively increase matrix rigidity and stabilize the three-dimensional structure. Carbon fibers embedded within the matrix may remain integrated within surrounding network regions and become mechanically anchored through geopolymer structures formed around exposed fiber surfaces.

For example, matrix regions initially containing partially developed gel phases after precursor preparation may continue evolving during curing into interconnected rigid structures extending across multiple board thickness regions. Network continuity established through progressive geopolymerization may reduce occurrence of isolated matrix domains and permit formation of a substantially integrated reinforcement-supported architecture. Consequently, sequential development of the interconnected aluminosilicate network contributes toward improved matrix continuity, enhanced reinforcement integration, reduced structural discontinuities, and more uniform mechanical behavior throughout the completed carbon fiber reinforced geopolymer composite board.

In an embodiment, actuating the vibration compaction apparatus at 50 Hz, 0.4 mm amplitude and 90 seconds vibration duration produces oscillatory movement propagating through a lower mold region and an upper mold region such that entrapped air bubbles positioned within interior regions of the freshly cast geopolymer mixture undergo movement toward exposed upper surfaces of the freshly cast geopolymer mixture and air-containing regions within the freshly cast geopolymer mixture become progressively reduced during continued vibration movement, and wherein continued vibration movement through the freshly cast geopolymer mixture simultaneously redistributes the quantity of carbon fibers and geopolymer constituents through the mold cavity during the vibration duration of 90 seconds, wherein repeated oscillatory propagation reduces density variation between central and peripheral mold regions prior to drying of the freshly cast geopolymer mixture.

In an embodiment, operation of the vibration compaction apparatus at a vibration frequency of approximately 50 Hz, a vibration amplitude of approximately 0.4 mm, and a vibration duration of approximately 90 seconds may establish a controlled oscillatory densification process configured to improve constituent uniformity and reduce internal structural discontinuities within the freshly cast geopolymer mixture prior to curing. Following transfer of the geopolymer precursor composition into the mold cavity, the freshly cast material may inherently contain entrapped gaseous regions, localized constituent concentration differences, and non-uniform particle packing arrangements generated during discharge and mold filling operations. Such internal heterogeneity may contribute to porosity development and matrix inconsistency following hardening if not corrected prior to geopolymer consolidation. Accordingly, controlled vibration propagation through the mold structure may be employed to induce redistribution and internal equalization within the precursor body.

The vibration compaction apparatus may include a vibrator mechanically coupled with a shaker platform supporting the mold containing the freshly cast geopolymer mixture. Upon activation, oscillatory displacement generated by the vibrator may propagate through the mold base and subsequently through lower mold regions, central mold regions, and upper mold regions. Repeated acceleration and deceleration cycles generated during oscillation create transient inertial forces within the geopolymer mixture, causing movement of liquid phases, suspended particulate constituents, and gaseous inclusions throughout the precursor body. Operation at approximately 50 Hz may generate sufficiently frequent displacement cycles to induce constituent movement without causing substantial separation of precursor components, while the vibration amplitude of approximately 0.4 mm may provide adequate internal energy transfer for mobilizing entrapped inclusions and suspended materials.

As vibration waves propagate through the freshly cast geopolymer mixture, entrapped air bubbles positioned within interior regions may undergo repeated displacement resulting from changing pressure distributions and oscillatory movement of surrounding material. Gaseous inclusions initially retained within liquid-filled and particulate-rich regions may gradually detach from surrounding precursor structures and migrate toward exposed upper surfaces due to combined buoyancy effects and repeated oscillatory acceleration. Continued vibration movement during the approximately 90-second duration progressively reduces air-containing regions distributed throughout internal portions of the precursor body. Removal of such entrapped gaseous inclusions reduces occurrence of isolated void regions that may otherwise remain embedded within the hardened geopolymer structure.

For example, during mold filling operations, air pockets may become trapped near lower mold regions or between concentrated constituent regions where flow disturbances occur during precursor deposition. In the absence of vibration-assisted compaction, such entrapped gaseous regions may remain immobilized and subsequently generate internal porosity after curing. Under controlled vibration propagation, repeated oscillatory cycles may permit these internal air regions to migrate through interconnected liquid pathways toward exposed upper surfaces where release may occur, thereby reducing void concentration throughout the precursor composition.

Simultaneously with air displacement processes, continued vibration movement may induce redistribution of geopolymer constituents and embedded carbon fibers through the mold cavity. Carbon fibers suspended within the precursor composition may experience localized positional adjustments due to oscillatory movement and changing inertial conditions generated throughout the precursor volume. Palm leaf ash particles, dissolved reactive species, watertight concrete constituents, and partially developed geopolymer regions may likewise undergo repeated movement and rearrangement. Such constituent redistribution may reduce concentration differences between localized regions and promote more uniform spatial distribution throughout the mold cavity.

Repeated oscillatory propagation may further contribute to reduction of density variation between central and peripheral mold regions. During casting operations, central regions and peripheral edge regions may initially exhibit differences in material packing behavior due to precursor flow characteristics and mold geometry effects. Oscillation-induced redistribution permits movement of constituents from relatively dense regions toward lower-density regions, thereby progressively equalizing material distribution throughout the precursor body. Lower mold regions, intermediate portions, and upper thickness regions may therefore acquire more balanced constituent arrangements prior to drying and geopolymer hardening.

For example, if higher constituent accumulation initially occurs near central mold regions while peripheral portions contain relatively greater air content or lower packing density, vibration-assisted propagation may permit repeated redistribution of precursor material toward under-filled or lower-density regions. Continued oscillatory movement throughout the vibration duration may therefore establish more homogeneous material organization across the mold cavity.

Following completion of vibration compaction and subsequent curing, the previously established constituent uniformity may facilitate formation of a geopolymer composite board exhibiting reduced internal porosity, improved matrix continuity, more uniform reinforcement distribution, and enhanced structural consistency across different board regions. Such internal equalization prior to drying contributes toward more stable geopolymer network formation and improved integration between the rigid aluminosilicate matrix and embedded carbon fiber reinforcement structures.

In an embodiment, maintaining the mold containing the freshly cast geopolymer mixture at 23 °C to 25 °C during drying comprises maintaining the freshly cast geopolymer mixture under laboratory ambient conditions prior to dry-air curing such that residual liquid regions within the freshly cast geopolymer mixture undergo progressive moisture reduction before demolding of the geopolymer composite board.

In an embodiment, maintaining the mold containing the freshly cast geopolymer mixture at approximately 23 °C to 25 °C during the drying stage may comprise a controlled pre-curing stabilization process configured to gradually condition the freshly cast geopolymer mixture before exposure to elevated-temperature curing conditions. Following completion of vibration compaction and mold filling operations, the geopolymer precursor composition may remain in a transitional state in which dissolved reactive species, liquid phases, suspended particulate constituents, and developing geopolymer gel regions continue undergoing structural evolution. Immediate exposure of the freshly cast mixture to elevated thermal conditions may induce abrupt moisture loss and localized reaction acceleration, potentially producing internal stress development and non-uniform matrix consolidation. Accordingly, maintaining the mold under laboratory ambient conditions may provide an intermediate conditioning environment allowing gradual progression of drying and precursor stabilization before subsequent curing operations.

The laboratory ambient conditions may include substantially stable environmental parameters such as temperature conditions maintained within approximately 23 °C to 25 °C and controlled atmospheric exposure permitting natural moisture exchange between exposed precursor surfaces and the surrounding environment. During this period, residual liquid regions distributed throughout the freshly cast geopolymer mixture may undergo progressive moisture reduction through controlled evaporation mechanisms. Free moisture present within surface regions and interconnected pore spaces may gradually migrate toward exposed external regions and evaporate over time without creating abrupt moisture gradients through the precursor body.

Residual liquid regions within the geopolymer mixture may include physically retained water, liquid phases surrounding dissolved silicon-containing species and dissolved aluminum-containing species, and moisture occupying interstitial spaces between particulate constituents and embedded carbon fibers. Controlled reduction of such moisture may gradually increase local solid concentration and permit continued development of early geopolymer interactions within the matrix. Since moisture removal occurs progressively rather than rapidly, developing gel structures may retain sufficient structural continuity while precursor regions undergo gradual consolidation.

For example, if the freshly cast geopolymer mixture is immediately transferred into a high-temperature curing environment without an intermediate ambient conditioning stage, surface regions may experience accelerated moisture removal while internal portions remain comparatively moisture-rich. Such unequal moisture reduction may create localized shrinkage differentials between surface and internal regions, potentially generating microcracks, edge distortion, or matrix discontinuities. By contrast, maintaining the mold at approximately room temperature prior to thermal curing allows residual liquid regions throughout lower, central, and upper portions of the freshly cast mixture to undergo more balanced moisture reduction.

Maintaining the precursor composition within the mold during this ambient stabilization stage may additionally preserve geometric stability and dimensional integrity while early-stage geopolymer gel regions continue strengthening. The mold structure may function as a supporting boundary preventing deformation of partially consolidated regions during moisture reduction. During this interval, developing matrix structures may gradually acquire sufficient cohesion and rigidity to withstand subsequent demolding operations without structural disturbance.

As progressive moisture reduction continues, the geopolymer composite board may transition from a highly flowable precursor state toward a partially stabilized body exhibiting improved dimensional stability and reduced free liquid content. Such controlled conditioning prior to demolding and dry-air curing contributes toward improved moisture uniformity, reduced shrinkage-related defects, more stable precursor consolidation, and enhanced continuity of matrix development during later curing stages, thereby facilitating formation of a more structurally consistent carbon fiber reinforced geopolymer composite board.

In an embodiment, curing at 90 °C for 24 hours followed by ambient curing at 23±2 °C for 90 days comprises maintaining the geopolymer composite board under a first curing stage sufficient to accelerate geopolymer reaction progression and a second curing stage sufficient to continue conversion of geopolymer gel regions into a hardened geopolymer composite board containing a rigid aluminosilicate matrix extending around the quantity of carbon fibers and throughout the geopolymer composite board.

In an embodiment, the curing sequence comprising an elevated-temperature stage followed by prolonged ambient conditioning may function as a controlled two-stage matrix maturation process configured to progressively convert the geopolymer precursor composition into a structurally integrated carbon fiber reinforced geopolymer composite board. The two curing stages may perform different but complementary functions during matrix development. The initial elevated-temperature stage may accelerate reaction kinetics and facilitate rapid formation of interconnected geopolymer structures, while the subsequent ambient conditioning stage may permit continuation of slower reaction mechanisms responsible for network densification, structural stabilization, and long-term matrix maturation. The sequential arrangement therefore allows reaction progression to occur under conditions suitable for both rapid precursor transformation and continued structural development.

During the first curing stage, the geopolymer composite board may be maintained at approximately 90 °C for approximately 24 hours within a dry-air curing environment following initial drying and demolding operations. Exposure to elevated temperature conditions may increase mobility of dissolved silicon-containing species and dissolved aluminum-containing species remaining within partially reacted geopolymer regions. Increased thermal energy supplied during oven curing may facilitate continued interaction among reactive species and accelerate condensation reactions responsible for formation of Si—O—Al linkages throughout the geopolymer matrix. Simultaneously, elevated temperature conditions may increase reaction rates associated with development of aluminosilicate chain structures and expansion of interconnected geopolymer regions throughout the board.

The first curing stage may additionally facilitate reduction of residual moisture retained within liquid-filled regions and partially developed gel structures. Controlled moisture removal under dry-air conditions permits reduction of excess water content while minimizing liquid entrapment within subsequently hardened regions. Removal of excess liquid may increase contact frequency among reactive constituents and permit closer structural organization of developing geopolymer frameworks. Continued thermal activation during this stage therefore promotes conversion of initially dispersed gel structures into increasingly interconnected matrix regions extending around embedded carbon fibers and through surrounding precursor regions.

For example, matrix regions positioned near embedded carbon fibers may initially contain partially developed geopolymer gel phases after completion of mixing and casting operations. Exposure to elevated temperature conditions during the first curing stage may accelerate interaction between surrounding dissolved species and neighboring gel structures, thereby promoting increased matrix continuity around reinforcement elements. Carbon fibers distributed through lower, central, and upper regions of the board may consequently become progressively surrounded by increasingly consolidated geopolymer structures.

Following completion of the elevated-temperature curing period, the geopolymer composite board may undergo a second curing stage under ambient conditions maintained at approximately 23±2 °C for approximately 90 days. Unlike the first stage, which primarily accelerates reaction progression, the second stage may provide a lower-energy environment permitting continuation of slower geopolymerization pathways and structural maturation mechanisms. Residual dissolved species and incompletely reacted gel regions remaining after thermal treatment may continue participating in additional condensation reactions and network extension processes over prolonged durations.

During this ambient curing stage, geopolymer gel regions distributed throughout the matrix may continue undergoing conversion into increasingly rigid aluminosilicate structures. Existing Si—O—Al linkages formed during earlier stages may progressively interconnect with neighboring chain structures and develop more extensive three-dimensional network architectures. Regions previously containing partially developed gel phases may continue evolving into denser interconnected structures extending across multiple board regions and reinforcement-containing portions of the composite structure.

For example, localized gel regions initially formed between adjacent carbon fibers during precursor preparation may remain partially interconnected after completion of elevated-temperature curing. During prolonged ambient conditioning, continued reaction progression may permit these regions to expand and merge with neighboring network structures, thereby improving matrix continuity and reinforcement integration throughout the board thickness direction.

As curing progresses through the combined stages, geopolymer gel regions surrounding the quantity of carbon fibers may gradually transform into a rigid aluminosilicate matrix extending around exposed fiber surfaces and throughout adjacent matrix regions. Matrix-fiber interface regions established during precursor preparation may undergo additional consolidation and stabilization, thereby strengthening interaction between the embedded carbon fibers and surrounding geopolymer structures. Consequently, the sequential curing arrangement contributes toward more complete reaction progression, improved network continuity, enhanced matrix consolidation, reduced structural heterogeneity, and formation of a hardened geopolymer composite board exhibiting substantially integrated reinforcement-supported matrix characteristics throughout the completed structure.

In an embodiment, introducing the quantity of carbon fibers comprises positioning a carbon fiber mesh within an interior region of the mold prior to introduction of the geopolymer precursor composition and further introducing randomly dispersed short carbon fibers into the geopolymer precursor composition during the final mixing stage such that the carbon fiber mesh occupies a board-thickness reinforcement region and the randomly dispersed short carbon fibers occupy matrix regions surrounding the carbon fiber mesh within the geopolymer composite board.

Prior to introduction of the geopolymer precursor composition into the mold, a carbon fiber mesh may be positioned within an interior region of the mold cavity at a predetermined depth corresponding to a selected reinforcement zone. The mesh may comprise intersecting carbon fiber strands arranged according to woven, orthogonal, lattice-type, or interconnected configurations capable of extending across a substantial portion of the board area. Positioning of the mesh within an intermediate mold region may allow the reinforcement structure to occupy a board-thickness reinforcement region extending through central portions of the geopolymer composite board. The mesh may therefore function as a continuous reinforcement framework capable of providing structural continuity across relatively larger dimensions of the board geometry.

Placement of the carbon fiber mesh prior to precursor introduction may further permit geopolymer material subsequently introduced into the mold cavity to flow around and through openings present within the mesh structure. During filling of the mold, precursor material may penetrate mesh interstitial regions and occupy spaces between adjacent fiber intersections. Such precursor infiltration may increase contact area between the developing geopolymer matrix and the reinforcement structure and facilitate establishment of matrix anchoring regions after curing. Positioning of the mesh within interior mold regions additionally permits reinforcement placement away from exposed board surfaces where surface irregularities or processing disturbances could otherwise influence reinforcement behavior.

Simultaneously, randomly dispersed short carbon fibers may be introduced into the geopolymer precursor composition during the final mixing stage according to the previously described controlled addition sequence. These short fibers may remain suspended throughout the precursor material and become distributed within matrix regions surrounding the carbon fiber mesh following mold filling operations. Unlike the mesh structure, which primarily occupies a defined reinforcement plane or thickness region, the dispersed fibers may become distributed through surrounding matrix portions extending above, below, and laterally around the mesh reinforcement structure.

For example, a carbon fiber mesh positioned approximately near a central board thickness region may establish a continuous reinforcement layer extending across the principal dimensions of the mold cavity. During subsequent mold filling operations, precursor composition containing dispersed short fibers may occupy regions positioned both above and below the mesh layer. As geopolymer precursor material flows through mesh openings and around embedded reinforcement strands, dispersed fibers may become positioned throughout surrounding matrix regions and establish distributed reinforcement pathways extending into regions not directly occupied by the mesh.

As geopolymerization progresses, developing geopolymer gel regions may form around both the carbon fiber mesh and the dispersed short fibers. Gel structures generated within mesh-adjacent regions may progressively occupy spaces surrounding intersecting mesh strands and infiltrated openings, thereby establishing reinforcement anchoring regions integrated with the surrounding matrix. Simultaneously, dispersed short fibers positioned throughout surrounding matrix regions may become individually encapsulated by geopolymer gel and later integrated into the developing aluminosilicate structure.

During curing, geopolymer gel regions surrounding both reinforcement configurations may convert into rigid matrix structures extending throughout the composite board. The mesh reinforcement may provide load redistribution capability across larger board dimensions and through-thickness reinforcement continuity, while the randomly dispersed short fibers may provide localized crack interruption and stress redistribution functions within adjacent matrix regions. Under loading conditions, stresses generated within matrix regions may therefore be transferred through multiple reinforcement pathways rather than concentrating within isolated regions.

For example, a crack initiated within a matrix region positioned above the carbon fiber mesh may first encounter randomly dispersed short fibers capable of interrupting local crack progression. If crack propagation continues toward central board regions, the advancing crack path may subsequently encounter the continuous mesh reinforcement structure, thereby introducing additional resistance and redistributing loading through neighboring matrix regions. Such multi-region reinforcement interaction permits more distributed structural response behavior throughout the board thickness direction.

Consequently, integration of a carbon fiber mesh with surrounding dispersed short fibers contributes toward improved reinforcement continuity, enhanced matrix anchoring behavior, more distributed stress transfer pathways, reduced concentration of localized fracture regions, and improved structural consistency throughout the completed carbon fiber reinforced geopolymer composite board.

In an embodiment, geopolymerization within the geopolymer precursor composition proceeds through sequential reaction stages comprising dissolution of silicon-containing species and aluminum-containing species from the palm leaf ash particles, formation of geopolymer gel regions containing the dissolved silicon-containing species and dissolved aluminum-containing species, propagation of interconnected Si—O—Al aluminosilicate network regions around the quantity of carbon fibers, and conversion of the interconnected Si—O—Al aluminosilicate network regions into the rigid aluminosilicate matrix during curing.

During an initial stage, dissolution of silicon-containing species and aluminum-containing species may occur upon exposure of palm leaf ash particles to the sodium hydroxide activating solution. Palm leaf ash generated through controlled combustion processes may contain silica-rich and alumina-containing phases present in relatively stable mineral structures. Hydroxyl ions introduced through the activating solution may progressively attack exposed surface regions of the ash particles and destabilize oxygen-linked structures containing silicon and aluminum constituents. Surface dissolution initially occurs at exposed reactive sites including particle boundaries, microstructural irregularities, and fractured surface regions. Continued alkaline exposure gradually releases silicon-containing species and aluminum-containing species into surrounding liquid-filled regions of the geopolymer precursor composition.

As rotational mixing continues within the mortar mixer, dissolved species generated at particle surfaces may migrate through the liquid phase and become distributed throughout the precursor body. Such migration permits reactive species generated at one location to occupy multiple precursor regions rather than remaining confined to isolated dissolution zones. Progressive increase in dissolved species concentration throughout the precursor composition establishes conditions suitable for initiation of subsequent geopolymerization stages.

Following sufficient accumulation of dissolved reactive species, formation of geopolymer gel regions may begin through interaction among dissolved silicon-containing species and dissolved aluminum-containing species distributed within the precursor medium. These dissolved species may undergo association and condensation reactions resulting in formation of smaller oligomer structures and localized reaction clusters. Continued interaction among these structures permits generation of geopolymer gel regions occupying spaces between particulate constituents and surrounding reinforcement structures. The gel regions may initially exist as semi-continuous reaction domains dispersed throughout the precursor composition.

As gel regions continue developing, interconnected Si—O—Al aluminosilicate network regions may begin propagating throughout the geopolymer precursor composition. Continued condensation reactions among neighboring gel structures and reactive species permit expansion of interconnected oxygen-linked bonds connecting silicon-containing and aluminum-containing constituents. Such interconnected network growth may occur both within matrix regions and around the quantity of carbon fibers distributed throughout the precursor composition. Carbon fibers positioned within lower, central, and upper regions of the precursor body may therefore become progressively surrounded by expanding geopolymer structures.

Propagation around carbon fibers may establish matrix-fiber interface regions integrated within the developing network architecture. Geopolymer structures generated around exposed fiber surfaces may gradually merge with neighboring gel regions positioned between adjacent fibers and surrounding matrix portions. As additional network propagation occurs, individual reaction domains surrounding neighboring fibers may interconnect and form continuous pathways extending through multiple reinforcement regions.

For example, carbon fibers positioned within separate portions of the precursor composition may initially become surrounded by localized geopolymer gel structures. Continued reaction progression may permit these initially isolated regions to expand and merge with neighboring network regions extending through surrounding matrix portions. The resulting interconnected structure may therefore establish continuous reinforcement-supported pathways distributed throughout the precursor volume.

During subsequent curing operations, the interconnected aluminosilicate network regions may undergo conversion into a rigid matrix structure extending throughout the geopolymer composite board. Elevated-temperature curing and prolonged ambient conditioning may facilitate removal of residual moisture, continued condensation reactions, and densification of developing network structures. Geopolymer gel regions may progressively transition into increasingly consolidated aluminosilicate frameworks possessing enhanced structural continuity and mechanical stability.

As curing proceeds, interconnected network regions surrounding carbon fibers and matrix regions may become integrated into a substantially continuous rigid aluminosilicate matrix extending through the completed composite board. Carbon fibers embedded within these matrix regions may become mechanically anchored by surrounding geopolymer structures, thereby improving reinforcement integration and structural interaction throughout the board. Consequently, the disclosed sequential geopolymerization process permits progressive transformation of dissolved precursor constituents into an interconnected reinforcement-supported matrix architecture exhibiting improved structural continuity, reduced reaction non-uniformity, enhanced reinforcement integration, and more consistent material behavior throughout the geopolymer composite board.

In an embodiment, vibration movement generated by the vibration compaction apparatus propagates through lower mold regions, central mold regions and upper mold regions during the vibration duration of 90 seconds such that geopolymer constituents positioned through different thickness regions of the freshly cast geopolymer mixture undergo redistribution and density equalization through the board thickness direction.

In an embodiment, vibration movement generated by the vibration compaction apparatus may propagate through lower mold regions, central mold regions, and upper mold regions according to a controlled mechanical energy transfer process configured to establish substantially uniform constituent distribution throughout the thickness of the freshly cast geopolymer mixture. Following introduction of the geopolymer precursor composition into the mold cavity, the precursor body may exhibit localized variations in constituent concentration and material packing due to gravitational settling, mold filling behavior, precursor flow characteristics, and reinforcement positioning during casting operations. Such variations may create differences in density through the thickness direction of the freshly cast mixture, potentially resulting in non-uniform matrix properties and internal structural inconsistencies after curing. Accordingly, vibration propagation through multiple thickness regions of the mold may be employed to redistribute geopolymer constituents and establish density equalization before hardening occurs.

The vibration compaction apparatus may include a shaker platform mechanically coupled to a vibration-generating assembly capable of producing repeated oscillatory displacement cycles. Upon activation, vibration movement generated at the mold support interface may initially propagate through lower mold regions and subsequently transmit through central and upper regions of the mold cavity. Such propagation creates repeated acceleration and deceleration forces within the freshly cast geopolymer mixture and generates transient movement of liquid phases, suspended particles, dissolved species, and reinforcement constituents distributed throughout the precursor body. Because vibration energy travels progressively through different thickness regions, constituents located at varying vertical positions may undergo repeated displacement during the vibration duration of approximately 90 seconds.

During vibration propagation through lower mold regions, particulate constituents including palm leaf ash particles, watertight concrete constituents, and developing geopolymer regions positioned near the mold base may experience movement and rearrangement resulting from oscillatory acceleration forces. Material portions initially exhibiting relatively high constituent concentration or increased packing density may undergo localized redistribution toward neighboring regions exhibiting comparatively lower constituent density. Such movement may reduce localized accumulation and establish more balanced constituent organization near the lower portions of the precursor body.

Simultaneously, vibration energy transmitted through central mold regions may induce movement of suspended carbon fibers, liquid-filled precursor regions, and partially developed geopolymer structures positioned through intermediate portions of the mold cavity. Central regions may initially experience concentration differences resulting from flow patterns generated during mold filling or reinforcement positioning operations. Oscillatory propagation through these regions may therefore promote redistribution of suspended constituents and facilitate movement of materials toward under-filled or lower-density regions.

Likewise, upper mold regions positioned adjacent exposed precursor surfaces may undergo repeated movement as vibration energy continues propagating through the freshly cast geopolymer mixture. Material regions near exposed surfaces may initially contain increased concentrations of liquid phases or air-containing regions resulting from precursor deposition behavior. Continued vibration movement through upper portions of the precursor body may therefore contribute toward redistribution of such regions and permit more balanced constituent arrangements across different thickness locations.

For example, during mold filling operations, heavier particulate constituents may settle preferentially toward lower mold regions while carbon fibers and liquid-rich precursor regions remain distributed through central or upper portions of the mold cavity. In the absence of vibration-assisted redistribution, such localized concentration differences may remain preserved during curing and create density gradients extending through the thickness direction of the resulting board. Under controlled oscillatory propagation, repeated constituent movement may permit material migration across neighboring regions and progressively reduce density variation through the precursor structure.

As vibration cycles continue during the approximately 90-second duration, repeated movement of geopolymer constituents through lower, central, and upper thickness regions may permit progressive density equalization across the board thickness direction. Redistribution of suspended particles, dissolved reactive species, liquid phases, and reinforcement constituents may create more homogeneous material organization throughout the precursor body prior to drying and geopolymer consolidation. Consequently, subsequent curing operations may proceed within a precursor structure exhibiting reduced thickness-related density variations, improved constituent continuity, enhanced matrix uniformity, and more consistent reinforcement distribution throughout the completed carbon fiber reinforced geopolymer composite board.

In an embodiment, the interconnected Si—O—Al aluminosilicate network generated during curing extends around exposed surface regions of the quantity of carbon fibers and forms geopolymer anchoring regions positioned between adjacent carbon fibers and surrounding geopolymer matrix regions.

In an embodiment, the interconnected Si—O—Al aluminosilicate network generated during curing may extend around exposed surface regions of the quantity of carbon fibers through a progressive matrix-fiber integration process configured to establish mechanically stable anchoring interfaces throughout the geopolymer composite structure. Rather than remaining limited to bulk matrix regions alone, the aluminosilicate network may develop continuously through regions immediately adjacent to the embedded carbon fibers such that geopolymer structures become integrated with reinforcement surfaces during matrix maturation. Formation of these matrix-fiber interaction regions may permit embedded carbon fibers to function as structurally integrated reinforcement elements rather than isolated inclusions suspended within the cured matrix.

During precursor preparation and early geopolymerization stages, dissolved silicon-containing species and dissolved aluminum-containing species distributed within the geopolymer precursor composition may migrate toward regions occupied by the carbon fibers. Since the carbon fibers are positioned through interstitial precursor regions and surrounded by liquid-filled geopolymer phases, reactive species present within surrounding precursor regions may continuously interact within fiber-adjacent environments. Initial geopolymer gel development may therefore occur not only within matrix regions positioned between neighboring fibers but also around exposed surface regions of individual carbon fibers distributed throughout the precursor body.

As geopolymerization progresses during curing, repeated condensation and network growth reactions may permit interconnected Si—O—Al linkages to propagate around exposed fiber surfaces. The developing geopolymer network may gradually occupy spaces surrounding carbon fibers and extend into narrow regions positioned between adjacent fibers and neighboring matrix structures. Such progressive network expansion may create interface zones where rigid aluminosilicate structures become geometrically integrated with embedded reinforcement regions.

For example, carbon fibers positioned within closely spaced matrix regions may initially be surrounded by localized geopolymer gel domains generated from dissolved reactive species present in surrounding precursor material. As curing proceeds, neighboring gel regions positioned around adjacent fibers may progressively expand and merge with surrounding matrix gel structures. Continued propagation of interconnected Si—O—Al linkages may therefore generate geopolymer anchoring regions occupying spaces between neighboring fibers and surrounding matrix portions.

The geopolymer anchoring regions may comprise localized matrix structures extending around exposed carbon fiber surfaces and into interstitial spaces between adjacent fibers. Such regions may provide reinforcement integration through mechanical interlocking and geometric confinement mechanisms generated by the surrounding rigid matrix architecture. Because the aluminosilicate network develops directly around exposed surface regions rather than merely contacting external fiber boundaries, the resulting matrix-fiber interfaces may exhibit increased continuity throughout the cured composite structure.

Formation of anchoring regions between adjacent carbon fibers may further contribute to establishment of interconnected reinforcement-supported pathways extending throughout the geopolymer composite board. Carbon fibers positioned throughout lower, central, and upper board regions may therefore become integrated within surrounding matrix structures through localized geopolymer bridges extending between neighboring reinforcement elements and adjacent matrix regions. Such bridging regions may facilitate transfer of forces through multiple pathways rather than concentrating stresses at isolated interface locations.

For example, under compressive or flexural loading conditions, localized matrix stresses generated near reinforcement regions may be transferred through geopolymer anchoring regions surrounding embedded fibers and subsequently redistributed toward adjacent matrix portions and neighboring reinforcement elements. Since the carbon fibers remain integrated within surrounding aluminosilicate structures, localized stress concentrations may become dispersed through broader matrix regions rather than remaining confined near isolated fiber boundaries.

As curing continues and geopolymer gel regions undergo conversion into a rigid aluminosilicate matrix, the interconnected network extending around exposed carbon fiber surfaces and through neighboring anchoring regions may become increasingly consolidated. Consequently, the resulting composite board may exhibit improved matrix-fiber integration, enhanced reinforcement retention characteristics, reduced likelihood of localized interface discontinuities, and more uniform structural interaction between embedded carbon fibers and the surrounding geopolymer matrix throughout the completed carbon fiber reinforced geopolymer composite board.

In an embodiment, continued mixing and curing of the geopolymer precursor composition positions the quantity of carbon fibers through matrix regions of the geopolymer composite board in a distributed arrangement such that crack propagation regions generated under compressive loading extend across multiple carbon-fiber reinforcement regions.

In an embodiment, continued mixing and curing of the geopolymer precursor composition may establish a distributed reinforcement architecture in which the quantity of carbon fibers becomes positioned throughout matrix regions of the geopolymer composite board according to a substantially dispersed arrangement capable of interacting with crack development pathways generated during mechanical loading conditions. Rather than remaining concentrated within isolated portions of the matrix, the carbon fibers may become spatially distributed through lower, central, and upper regions of the composite structure as a consequence of controlled mixing operations, precursor flow behavior, vibration-assisted redistribution, and subsequent matrix consolidation during curing. Such distributed positioning may permit reinforcement pathways to extend throughout multiple portions of the geopolymer matrix and establish internal regions capable of influencing crack behavior during loading events. The distributed arrangement may position carbon fibers according to partially random orientations and spatial locations throughout the geopolymer matrix rather than concentrating reinforcement along a single plane or direction. Individual fibers positioned within neighboring regions may therefore collectively establish multiple reinforcement zones distributed throughout the board structure. Such distributed reinforcement architecture may create a network of reinforcement-containing regions extending across various matrix locations and thickness portions of the composite board.

Under compressive loading conditions, localized stress concentrations may initially develop within matrix regions exhibiting microstructural defects, pore regions, or material discontinuities. Continued application of compressive forces may produce crack initiation regions that subsequently evolve into propagating crack pathways extending through the geopolymer matrix. In conventional brittle matrix systems lacking distributed reinforcement, such crack pathways may progress along energetically favorable directions and rapidly extend through matrix regions with minimal interruption. In contrast, the distributed carbon-fiber arrangement may alter crack progression behavior by introducing multiple reinforcement-containing regions positioned throughout potential propagation pathways.

For example, a crack initiated within a lower matrix region during compressive loading may initially propagate through adjacent geopolymer regions until encountering an embedded carbon fiber positioned within its advancement path. Interaction with the reinforcement region may locally modify stress distribution and alter crack movement behavior. If crack progression continues beyond the initial reinforcement location, subsequent propagation regions may intersect additional carbon-fiber reinforcement regions distributed through neighboring matrix portions. Consequently, the crack path may extend across multiple reinforcement regions rather than progressing uninterrupted through a continuous brittle matrix region.

Because the carbon fibers remain distributed through multiple matrix locations, crack propagation regions generated during loading may repeatedly encounter reinforcement-supported areas throughout lower, central, and upper portions of the composite structure. Matrix-fiber interface regions surrounding embedded fibers may redistribute localized stresses into neighboring geopolymer regions and reduce concentration of loading effects within isolated crack tips. Repeated interaction with multiple reinforcement zones may therefore modify crack trajectories and distribute deformation across broader portions of the matrix structure.

For instance, crack advancement occurring through central board regions may encounter a first reinforcement region causing localized deviation of the crack path, followed by interaction with neighboring distributed fibers positioned through adjacent matrix regions. Continued crack movement may therefore require progression through a sequence of reinforcement-containing zones rather than through a single uninterrupted matrix pathway. Such distributed interaction mechanisms may contribute toward more gradual crack extension behavior and improved load redistribution characteristics throughout the composite board.

As curing progresses and matrix consolidation becomes complete, the distributed carbon-fiber arrangement integrated within the rigid aluminosilicate structure may establish reinforcement continuity across multiple matrix regions. Consequently, the completed geopolymer composite board may exhibit improved resistance to localized fracture progression, enhanced load redistribution pathways, reduced concentration of structural discontinuities, and more uniform mechanical response behavior during compressive loading conditions.

In an embodiment, the quantity of carbon fibers is distributed through the geopolymer precursor composition according to a reinforcement arrangement comprising randomly dispersed reinforcement regions and aligned reinforcement regions extending through separate portions of the geopolymer precursor composition such that geopolymer gel formation occurs around carbon fibers positioned according to different reinforcement orientations within the geopolymer precursor composition. Rather than restricting all reinforcement elements to a single orientation pattern, the disclosed arrangement may establish reinforcement structures having differing geometric distributions capable of interacting with matrix development and subsequent loading behavior through distinct mechanisms.

The randomly dispersed reinforcement regions may comprise chopped carbon fibers introduced during the mixing process and distributed through the geopolymer precursor composition according to circulation patterns generated within the mortar mixer. During continued rotational movement, individual fibers may migrate through interstitial precursor spaces and become positioned according to substantially non-uniform and multidirectional orientations. Such random distribution may allow fibers to occupy matrix regions extending through lower, central, and upper portions of the precursor composition while simultaneously extending across multiple spatial directions. The dispersed arrangement may therefore create localized reinforcement pathways capable of interacting with stresses and crack propagation events originating from different orientations within the cured board structure.

In contrast, aligned reinforcement regions may comprise carbon fibers intentionally positioned according to predetermined directional arrangements prior to or during precursor introduction into the mold cavity. Such aligned regions may be established using reinforcement meshes, continuous fiber layers, directional fiber arrays, or controlled placement structures extending through selected portions of the geopolymer precursor composition. Unlike randomly dispersed fibers, aligned fibers may occupy specific orientations extending along longitudinal, transverse, diagonal, or through-thickness directions depending upon the anticipated loading conditions and structural requirements of the geopolymer composite board.

For example, a reinforcement arrangement may include a centrally positioned carbon fiber mesh extending substantially along longitudinal and transverse directions through intermediate board regions while randomly dispersed short carbon fibers remain distributed throughout surrounding precursor regions. The aligned mesh structure may establish continuous reinforcement pathways extending across larger board dimensions, whereas dispersed fibers positioned above and below the mesh may create multidirectional reinforcement zones throughout neighboring matrix portions. Consequently, separate portions of the precursor composition may contain reinforcement structures exhibiting substantially different orientation characteristics.

As dissolved silicon-containing species and dissolved aluminum-containing species continue interacting during geopolymerization, geopolymer gel formation may occur around carbon fibers occupying both randomly dispersed and aligned reinforcement regions. Because reinforcement elements positioned according to different orientations become surrounded by liquid-filled precursor material containing reactive species, developing geopolymer gel structures may progressively form around exposed fiber surfaces regardless of their orientation within the precursor composition. Initial geopolymer reaction regions may therefore emerge simultaneously around fibers positioned in random multidirectional arrangements and around fibers aligned according to predetermined directional pathways.

For instance, geopolymer gel structures generated around randomly dispersed fibers positioned near upper matrix regions may evolve simultaneously with gel regions surrounding aligned reinforcement elements extending through central portions of the precursor composition. Continued condensation reactions may permit neighboring gel regions surrounding different reinforcement structures to expand and interconnect with adjacent matrix regions. Consequently, matrix-fiber interface regions may develop around fibers exhibiting multiple orientation configurations distributed throughout the precursor body.

As curing progresses, geopolymer gel structures surrounding randomly dispersed reinforcement regions and aligned reinforcement regions may convert into rigid aluminosilicate structures integrated with surrounding carbon fibers. Fibers occupying different orientations may therefore become embedded within a continuous matrix while preserving their respective reinforcement configurations. Randomly oriented fibers may provide multidirectional crack interaction and localized stress redistribution behavior, whereas aligned reinforcement regions may provide enhanced load transfer capability along selected structural directions.

For example, under mechanical loading conditions, stresses generated within matrix regions may initially interact with randomly dispersed fibers capable of interrupting localized crack development in various directions. Simultaneously, aligned reinforcement regions extending through neighboring portions of the board may redistribute larger-scale loading effects along predefined reinforcement pathways. Such combined reinforcement interaction may permit more distributed structural response behavior compared with uniformly oriented reinforcement arrangements.

Consequently, the hybrid reinforcement architecture comprising randomly dispersed and aligned reinforcement regions contributes toward improved matrix-reinforcement integration, expanded reinforcement coverage across multiple structural regions, enhanced interaction between geopolymer gel development and embedded reinforcement structures, and more balanced mechanical performance throughout the completed carbon fiber reinforced geopolymer composite board.

In an embodiment, the interconnected Si—O—Al aluminosilicate network forms geopolymer regions surrounding the quantity of carbon fibers such that crack propagation regions entering carbon-fiber reinforced regions undergo directional deviation along matrix-fiber interface regions and continue through adjacent geopolymer regions positioned between neighboring carbon fibers, and wherein vibration movement generated by the vibration compaction apparatus redistributes the quantity of carbon fibers and geopolymer constituents during the vibration duration such that reinforcement-containing regions positioned through lower, central and upper thickness portions of the freshly cast geopolymer mixture undergo progressive density equalization prior to curing, and wherein geopolymerization comprises sequential formation of aluminosilicate chain regions followed by interconnection of aluminosilicate chain regions into three-dimensional interconnected network regions extending through geopolymer gel portions surrounding the quantity of carbon fibers.

During geopolymerization, dissolved silicon-containing species and dissolved aluminum-containing species distributed throughout the precursor composition may initially undergo interaction through condensation and association reactions to form early-stage aluminosilicate chain regions. These chain regions may represent initial reaction structures in which silicon-containing and aluminum-containing constituents become connected through oxygen linkages. Formation of such chain regions may occur throughout liquid-filled precursor spaces and may emerge simultaneously in matrix regions and reinforcement-adjacent environments surrounding embedded carbon fibers. Initially, these chain structures may remain localized and partially interconnected, forming precursor reaction domains distributed throughout the precursor composition.

As reaction progression continues, neighboring aluminosilicate chain regions may undergo further condensation and interconnection processes. Repeated interaction among adjacent reaction structures may permit progressive transformation from localized chain arrangements into larger interconnected three-dimensional network regions extending through the geopolymer gel portions surrounding the quantity of carbon fibers. Such three-dimensional propagation may allow network structures generated around neighboring fibers to merge and establish continuous matrix pathways extending throughout reinforcement-containing regions.

For example, carbon fibers distributed through lower, central, and upper portions of the geopolymer precursor composition may initially become surrounded by individual geopolymer gel regions containing developing aluminosilicate chain structures. Continued geopolymerization may permit chain growth around each fiber and eventual interconnection among neighboring chain regions positioned between adjacent fibers. As a result, initially separate geopolymer reaction regions may progressively evolve into interconnected network structures extending across multiple reinforcement regions and surrounding matrix portions.

The interconnected Si—O—Al aluminosilicate network generated around the carbon fibers may further establish matrix-fiber interface regions capable of influencing crack propagation behavior during subsequent loading conditions. Since geopolymer regions occupy spaces surrounding exposed carbon fiber surfaces and extend between neighboring fibers, crack propagation pathways entering carbon-fiber reinforced regions may encounter localized interface structures exhibiting different structural characteristics than surrounding matrix portions. Upon reaching reinforcement-containing regions, advancing crack fronts may experience modifications in local stress distribution and interaction with embedded reinforcement interfaces.

Simultaneously, prior to curing, vibration movement generated by the vibration compaction apparatus may contribute to establishment of reinforcement uniformity and constituent equalization throughout the precursor body. During the vibration duration, oscillatory movement propagating through the freshly cast geopolymer mixture may repeatedly redistribute carbon fibers and surrounding geopolymer constituents through lower, central, and upper thickness regions of the mold cavity. Such movement may permit reinforcement-containing regions initially exhibiting localized concentration differences to progressively undergo density equalization before matrix hardening occurs.

For example, if carbon fibers initially accumulate within central mold regions during casting operations, vibration-assisted propagation may induce repeated constituent movement causing fibers and surrounding precursor material to redistribute toward lower-density regions located within lower or upper mold portions. Repeated oscillatory movement throughout the vibration duration may therefore establish more balanced reinforcement distribution throughout the board thickness direction prior to curing.

As curing proceeds, the previously redistributed reinforcement regions and interconnected aluminosilicate structures may undergo consolidation into a rigid matrix architecture extending throughout the geopolymer composite board. The combined effects of network propagation around carbon fibers, interface-guided crack interaction, and vibration-assisted density equalization may therefore establish a reinforcement-supported structure exhibiting improved matrix continuity, enhanced reinforcement integration, more distributed crack interaction pathways, and increased structural uniformity throughout the completed carbon fiber reinforced geopolymer composite board.

In an embodiment, the present invention provides a carbon fiber reinforced geopolymer composite board. The composite board comprising a geopolymer matrix comprising palm leaf ash particles and watertight concrete powder activated using a sodium hydroxide activating solution prepared from sodium hydroxide pellets and distilled water, wherein the sodium hydroxide activating solution comprises sodium hydroxide concentration selected from 20 wt. % and 30 wt. %; a rigid aluminosilicate network extending through the geopolymer matrix and comprising interconnected Si—O—Al bonds generated through geopolymerization of dissolved silicon-containing species and dissolved aluminum-containing species derived from the palm leaf ash particles; a quantity of carbon fibers distributed within the geopolymer matrix and comprising 1.5 wt. % of total composite composition, wherein the quantity of carbon fibers comprises randomly dispersed short carbon fibers extending through interstitial regions of the geopolymer matrix; wherein the rigid aluminosilicate network surrounds exposed regions of the quantity of carbon fibers and forms reinforcement interfaces extending through the geopolymer matrix; and wherein the geopolymer matrix is formed from a composition comprising 700 g palm leaf ash particles, 300 g watertight concrete powder, 100 g sodium hydroxide pellets, and 300 g distilled water and cured at 90 °C for 24 hours followed by ambient curing at 23±2 °C for 90 days.

The geopolymer matrix may comprise palm leaf ash particles functioning as a principal source of silica-containing and alumina-containing constituents and watertight concrete powder functioning as a supplementary mineral constituent capable of contributing to matrix consolidation and pore reduction behavior. Palm leaf ash particles generated through controlled combustion and subsequent conditioning operations may contain reactive inorganic phases suitable for alkaline activation. The watertight concrete powder may include cementitious and mineral components capable of improving matrix continuity and reducing internal permeability characteristics within the composite structure. During precursor preparation, activation of these constituents may occur through a sodium hydroxide activating solution prepared from sodium hydroxide pellets and distilled water. The sodium hydroxide activating solution may comprise sodium hydroxide concentrations selected between approximately 20 wt. % and 30 wt. %, thereby establishing an alkaline environment sufficient to destabilize and dissolve reactive silica-containing and alumina-containing phases present within the palm leaf ash particles.

Upon interaction with the activating solution, hydroxyl ions generated within the alkaline medium may progressively dissolve exposed surface regions of the palm leaf ash particles and release dissolved silicon-containing species and dissolved aluminum-containing species into surrounding liquid-filled regions of the precursor composition. Continued interaction among these dissolved species may subsequently initiate geopolymerization processes resulting in generation of geopolymer gel regions and progressive development of interconnected aluminosilicate structures. Repeated condensation reactions among reactive species may establish interconnected Si—O—Al bonds extending throughout the developing matrix. These interconnected bonds may propagate through neighboring reaction domains and form a rigid aluminosilicate network extending continuously throughout the geopolymer matrix.

The rigid aluminosilicate network may therefore function as a principal load-supporting framework of the composite board and may extend through lower, central, and upper board regions while surrounding reinforcement-containing portions of the structure. Unlike isolated reaction clusters or discontinuous matrix regions, the interconnected network may establish substantially continuous pathways throughout the composite body and permit integrated load transfer across multiple matrix regions. Network continuity may further reduce occurrence of isolated weak regions and facilitate more balanced structural behavior throughout the completed board.

The quantity of carbon fibers distributed within the geopolymer matrix may comprise approximately 1.5 wt. % of the total composite composition and may include randomly dispersed short carbon fibers extending through interstitial matrix regions. These carbon fibers may possess dimensions and spatial arrangements permitting positioning throughout liquid-filled precursor regions and subsequently through geopolymer matrix portions generated during curing. Gradual introduction and controlled precursor mixing may distribute the carbon fibers throughout lower, central, and upper portions of the precursor body while reducing accumulation within isolated regions. Consequently, the fibers may establish multiple reinforcement pathways extending through the geopolymer matrix.

For example, randomly dispersed carbon fibers positioned throughout interstitial regions may occupy spaces between geopolymer matrix portions and extend across neighboring structural regions. Such distribution permits reinforcement elements to interact with multiple matrix locations and establish distributed crack interruption pathways after curing. Carbon fibers positioned through different orientations and locations may therefore collectively contribute to structural continuity throughout the board.

As geopolymerization and curing continue, the rigid aluminosilicate network may progressively surround exposed regions of the quantity of carbon fibers and establish reinforcement interfaces extending throughout the geopolymer matrix. These reinforcement interfaces may comprise matrix-fiber interaction regions where geopolymer structures develop around exposed carbon fiber surfaces and extend into adjacent matrix regions. Formation of such interface regions may permit mechanical anchoring and load transfer interactions between the surrounding matrix and embedded reinforcement structures.

The geopolymer matrix itself may be formed from a composition comprising approximately 700 g of palm leaf ash particles, approximately 300 g of watertight concrete powder, approximately 100 g of sodium hydroxide pellets, and approximately 300 g of distilled water. Such proportions may establish precursor conditions suitable for controlled dissolution, geopolymer gel generation, and network development throughout the composite body. Following precursor preparation and mold formation, the resulting board may undergo curing at approximately 90 °C for approximately 24 hours followed by ambient curing at approximately 23±2 °C for approximately 90 days. The elevated-temperature curing stage may accelerate geopolymer reaction progression and network development, while prolonged ambient conditioning may permit continued matrix maturation and consolidation.

For example, matrix regions initially containing partially developed geopolymer gel structures following precursor formation may continue evolving during thermal and ambient curing into rigid interconnected aluminosilicate structures extending throughout reinforcement-containing portions of the board. Carbon fibers distributed within these regions may become progressively anchored by surrounding matrix structures and integrated within the developing network architecture. Consequently, the completed carbon fiber reinforced geopolymer composite board may comprise a reinforcement-supported geopolymer structure exhibiting improved matrix continuity, reduced internal porosity, enhanced reinforcement integration, distributed load transfer pathways, and substantially uniform structural characteristics throughout the board thickness and planar regions.

In an embodiment, gradual introduction of the sodium hydroxide activating solution and subsequent increase of mortar mixer rotational speed establishes a temporally staged dissolution regime in which silicon-containing species and aluminum-containing species are released from the palm leaf ash particles at non-uniform reaction rates over successive mixing intervals, such that geopolymer gel formation initiates after establishment of substantially homogeneous alkaline exposure throughout the precursor composition, thereby reducing localized gel nucleation regions and generating an aluminosilicate matrix having reduced concentration gradients surrounding carbon-fiber reinforcement regions and wherein the quantity of carbon fibers dispersed within the geopolymer precursor composition becomes encapsulated by the interconnected Si—O—Al aluminosilicate network to generate distributed fiber-bridging regions configured to alter crack propagation behavior during compressive loading by promoting crack deflection, crack branching, and localized energy dissipation within the geopolymer composite board, thereby changing fracture progression from continuous longitudinal propagation toward discontinuous multi-region crack development.

During experimental implementation, a precursor composition including 700 g palm leaf ash particles, 300 g watertight concrete powder, and a sodium hydroxide activating solution containing 100 g sodium hydroxide dissolved within 300 g distilled water at 25 wt. % concentration may be subjected to a staged mixing sequence including dry mixing at 140±5 rpm for 2 minutes, gradual activator introduction over approximately 3 minutes while maintaining 140±5 rpm rotational movement, followed by increased rotational mixing at 285±10 rpm for approximately 2-3 minutes. Under such operating conditions, gradual alkaline exposure may permit distributed wetting of palm leaf ash particles before high-shear circulation initiates accelerated dissolution of silicon-containing and aluminum-containing species. For example, when the activator-to-solid ratio is maintained at approximately 0.40:1 and the water-to-solid ratio is maintained at approximately 0.30:1, the precursor composition may exhibit substantially continuous precursor development throughout the mortar mixer volume rather than isolated geopolymer gel-rich regions adjacent to activator introduction locations. Localized premature geopolymer gel formation near initial activator contact zones may therefore be reduced. Technical efficacy of the staged dissolution mechanism may be observed through generation of a more spatially uniform aluminosilicate matrix surrounding reinforcement regions and reduction of non-reactive or partially reacted domains within the cured board structure. For example, specimens produced using 30% sodium hydroxide concentration with carbon fiber reinforcement demonstrated substantially greater compression load capability than specimens prepared using 20% sodium hydroxide concentration without reinforcement, wherein average maximum loading increased from approximately 769.49 N to approximately 4006.10 N. Such increase may indicate more effective reaction continuity and improved matrix formation resulting from controlled precursor development. Furthermore, apparent modulus values increased from approximately 755.45 MPa to approximately 1911.8 MPa. The increase in stiffness may indicate improved load-transfer continuity through the geopolymer matrix and reduced occurrence of discontinuous internal structural regions. Accordingly, controlled staged dissolution may contribute to improved reaction uniformity and generation of a mechanically integrated geopolymer composite board exhibiting increased structural consistency across different regions of the composite.

During experimental implementation, approximately 21 g of carbon fibers corresponding to about 1.5 wt. % of the total composite composition may be introduced during the final two-minute mixing stage while the mortar mixer operates according to a total mixing duration of approximately 7-10 minutes. Continued rotational movement at approximately 285±10 rpm may distribute carbon fibers throughout the geopolymer precursor composition while dissolved silicon-containing species and dissolved aluminum-containing species continue formation of the geopolymer gel. During subsequent polycondensation and curing at approximately 90 °C for 24 hours followed by ambient curing at approximately 23±2 °C for 90 days, the aluminosilicate matrix may progressively surround portions of the embedded carbon fibers and establish distributed matrix-fiber interfacial regions throughout the hardened structure. For example, specimens including carbon fiber reinforcement and prepared using 30% sodium hydroxide concentration exhibited average maximum compressive loading values of approximately 4006.10 N compared with approximately 2808.65 N for corresponding specimens without carbon fibers. Additionally, compression yield stress increased from approximately 9.27 MPa to approximately 13.31 MPa. Such increase may indicate improved stress redistribution within the geopolymer matrix due to matrix-fiber interaction regions. Technical efficacy may further be observed during fracture progression. Photographic fracture configurations indicate that carbon-fiber reinforced structures exhibited altered fracture behavior relative to non-reinforced structures through changes in crack configuration and crack propagation characteristics. During loading, propagating crack fronts reaching embedded fiber regions may encounter local resistance caused by fibers extending across crack paths. Fiber-containing regions may redistribute localized stresses and alter crack trajectories by promoting crack deflection and segmented crack progression. Mechanical loading energy may therefore become distributed through multiple matrix-fiber interaction regions rather than remaining concentrated at a single advancing crack front. Consequently, the reinforced structure may exhibit delayed crack propagation behavior and improved retention of structural integrity during compressive loading.

FIG. 37 illustrates a block diagram for a system for manufacturing a carbon fiber reinforced geopolymer composite board. The system 3700 comprises: a stirrer plate (3702) configured to receive 100 g sodium hydroxide pellets and 300 g distilled water, wherein the stirrer plate operates at a rotational speed from 400 rpm to 600 rpm during a mixing period of 10 minutes to 15 minutes for preparation of a sodium hydroxide activating solution having 25 wt. % sodium hydroxide concentration; a mortar mixer (3704) configured to receive 700 g palm leaf ash particles and 300 g watertight concrete powder, wherein the mortar mixer operates at 140±5 rpm during a dry mixing stage and 285±10 rpm during a geopolymer precursor formation stage and further receives 21 g carbon fibers corresponding to 1.5 wt. % of total composite composition during a final mixing stage; a mold (3706) configured to receive a geopolymer precursor composition discharged from the mortar mixer; a vibration compaction apparatus (3708)comprising a shaker table platform and a vibrator configured to generate vibration movement at a frequency from 40 Hz-60 Hz, amplitude from 0.3 mm-0.5 mm, and vibration duration from 60 seconds-120 seconds through the mold and a freshly cast geopolymer mixture contained within the mold; and a curing arrangement (3710) configured to cure the freshly cast geopolymer mixture at 90 °C for 24 hours followed by ambient curing at 23±2 °C for 90 days, wherein operation of the mortar mixer and the vibration compaction apparatus establishes distribution of the carbon fibers through reinforcement regions positioned throughout the geopolymer precursor composition prior to curing.

FIG. 37 illustrates a system 3700 configured for manufacturing a carbon fiber reinforced geopolymer composite board through controlled preparation, activation, reinforcement incorporation, compaction, and curing operations performed in a sequential and coordinated manner. The system may comprise multiple interconnected processing components configured to establish controlled material transformation from raw precursor constituents into a hardened geopolymer composite structure possessing distributed carbon fiber reinforcement integrated within a rigid aluminosilicate matrix. Rather than operating as isolated processing devices, the system components may function cooperatively such that output conditions generated at one stage establish process conditions for subsequent stages, thereby facilitating continuous progression of precursor preparation and matrix development throughout the manufacturing sequence.

The system 3700 may comprise a stirrer plate 3702 configured to receive approximately 100 g sodium hydroxide pellets and approximately 300 g distilled water for preparation of a sodium hydroxide activating solution. The stirrer plate may include an electromagnetic drive arrangement configured to generate a rotating magnetic field beneath a mixing vessel containing the liquid medium and sodium hydroxide pellets. A magnetic stir bar positioned within the mixing vessel may respond to the rotating magnetic field and establish rotational movement throughout the liquid volume. Operation at rotational speeds ranging from approximately 400 rpm to 600 rpm for approximately 10 minutes to 15 minutes may generate continuous circulation patterns within the liquid body including vortex formation, radial movement, and vertical recirculation flow. Such movement repeatedly transports sodium hydroxide pellets through changing liquid environments and promotes progressive dissolution throughout the solution volume. During dissolution, sodium hydroxide pellets may dissociate into sodium ions and hydroxyl ions, thereby generating a substantially homogeneous sodium hydroxide activating solution possessing approximately 25 wt. % sodium hydroxide concentration suitable for subsequent geopolymer activation operations.

The system may further comprise a mortar mixer 3704 configured to receive approximately 700 g palm leaf ash particles and approximately 300 g watertight concrete powder. The mortar mixer may function as a controlled precursor generation arrangement capable of sequentially performing constituent distribution, alkaline activation, and reinforcement incorporation processes. During an initial dry mixing stage, operation at approximately 140±5 rpm may redistribute particulate constituents and establish a substantially homogeneous precursor mixture. Thereafter, the sodium hydroxide activating solution may be introduced into the mortar mixer and continued rotational operation may initiate alkaline interaction with reactive constituents present in the palm leaf ash particles. Rotational speed may subsequently increase to approximately 285±10 rpm during precursor formation stages to generate enhanced circulation movement and facilitate dissolution of silicon-containing species and aluminum-containing species into surrounding liquid-filled precursor regions. The system may additionally comprise a mold 3706 configured to receive the geopolymer precursor composition discharged from the mortar mixer. The mold may function as a geometric containment structure configured to define board dimensions and maintain precursor positioning during compaction and curing operations. Upon introduction of the precursor composition into the mold cavity, freshly cast geopolymer material may occupy the internal mold volume and contain dispersed carbon fibers, dissolved reactive species, and developing geopolymer regions distributed throughout the precursor body.

A vibration compaction apparatus 3708 comprising a shaker table platform and a vibrator may further be provided for compaction and constituent equalization operations. The vibration compaction apparatus may be configured to generate vibration movement at frequencies ranging from approximately 40 Hz to 60 Hz, amplitudes ranging from approximately 0.3 mm to 0.5 mm, and vibration durations ranging from approximately 60 seconds to 120 seconds through the mold and freshly cast geopolymer mixture contained therein. Oscillatory movement generated by the vibrator may propagate through lower mold regions, central mold regions, and upper mold regions to induce repeated movement of particulate constituents, liquid phases, and embedded reinforcement structures. Such propagation may facilitate displacement of entrapped air bubbles toward exposed upper surfaces while simultaneously redistributing geopolymer constituents and carbon fibers throughout the precursor body.

The system may further comprise a curing arrangement 3710 configured to cure the freshly cast geopolymer mixture according to a controlled multi-stage curing sequence. The curing arrangement may initially expose the geopolymer mixture to elevated-temperature conditions at approximately 90 °C for approximately 24 hours, followed by ambient curing at approximately 23±2 °C for approximately 90 days. During elevated-temperature exposure, thermal energy may accelerate geopolymer reaction progression and facilitate formation of interconnected Si—O—Al network structures throughout the precursor body. Prolonged ambient conditioning may thereafter permit continued geopolymer maturation and matrix stabilization through slower condensation and network development mechanisms. Operation of the mortar mixer and vibration compaction apparatus together may establish substantially distributed carbon-fiber reinforcement regions positioned throughout the geopolymer precursor composition prior to curing. The mortar mixer may initially disperse and position reinforcement structures within the precursor body, while the vibration compaction apparatus may further redistribute and equalize constituent arrangements through the mold thickness direction. Consequently, subsequent curing operations may proceed within a precursor structure exhibiting reduced density variation, improved reinforcement continuity, enhanced constituent uniformity, and more consistent matrix development characteristics throughout the resulting carbon fiber reinforced geopolymer composite board.

In an embodiment, the manufacturing arrangement comprises physically implemented processing components configured to perform material preparation, mixing, compaction, and curing operations for producing the carbon fiber reinforced geopolymer composite board. The stirrer plate is a physical electromechanical mixing component comprising a support platform, an electromagnetic drive assembly, a rotational field generation arrangement, and a mixing vessel receiving region configured to support a container holding sodium hydroxide pellets and distilled water. The stirrer plate further includes an electrical power supply interface and a rotating magnetic field generation mechanism configured to induce movement of a magnetic stir element positioned within the liquid medium, thereby producing physical circulation and dissolution of sodium hydroxide pellets within the activating solution. The mortar mixer is a mechanically implemented mixing apparatus comprising a mixing chamber, a rotatable mixing drum or container, motor-driven rotational shafts, mixing blades or paddles, transmission assemblies, and speed control components configured to establish rotational movement at selectable operating speeds. The mortar mixer physically receives palm leaf ash particles, watertight concrete powder, activating solution, and carbon fibers and subjects the introduced materials to repeated mechanical movement, circulation, and mixing operations for precursor formation. The mold is a structural containment component formed from rigid material and comprising sidewall structures, lower support surfaces, and an internal cavity configured to physically receive and maintain the geopolymer precursor composition according to a predetermined board geometry during subsequent processing operations. The vibration compaction apparatus comprises a physically implemented shaker table platform, a vibration generation assembly, a vibrator unit, mechanical coupling members, and support structures configured to transmit oscillatory movement through the mold and freshly cast geopolymer mixture. The shaker table physically supports the mold while the vibrator generates repeated displacement movement at predetermined frequencies and amplitudes for air displacement and constituent redistribution. The curing arrangement is a thermally controlled hardware structure comprising an enclosure chamber, heating elements, airflow pathways, temperature regulation assemblies, thermal insulation structures, and environmental conditioning components configured to expose the geopolymer composite board to controlled curing environments. The curing arrangement physically generates and maintains elevated temperature conditions and ambient conditioning environments required for matrix transformation and geopolymer maturation. Carbon fibers, palm leaf ash particles, sodium hydroxide pellets, distilled water, and watertight concrete powder likewise represent physical material constituents introduced into and processed by the foregoing mechanical structures. The cooperative interaction of these physical processing components establishes a complete material manufacturing architecture in which mechanical movement, vibration transfer, thermal conditioning, and structural containment operations are performed through physically implemented hardware elements to produce the geopolymer composite board structure.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A method for manufacturing a carbon fiber reinforced geopolymer composite board using palm leaf ash, sodium hydroxide pellets, distilled water, carbon fibers, watertight concrete powder, a mortar mixer, a mold and a vibration compaction apparatus, the method comprising:
preparing 700 g of palm leaf ash particles, corresponding to 70 wt. % of a total solid composition, by burning palm leaves, crushing burned palm leaf material and filtering crushed burned palm leaf material to remove impurities and obtain the palm leaf ash particles;
providing 300 g of watertight concrete powder, corresponding to 30 wt. % of the total solid composition, and dry mixing the palm leaf ash particles and the watertight concrete powder within the mortar mixer at a rotational speed of 140±5 rpm for 2 minutes;
mixing 100 g of the sodium hydroxide pellets with 300 g of the distilled water on a stirrer plate to form a sodium hydroxide activating solution, wherein the sodium hydroxide activating solution comprises 25 wt. % sodium hydroxide concentration, and wherein the sodium hydroxide activating solution is stirred at 400-600 rpm for 10-15 minutes and cooled to 23-25 °C;
gradually introducing the sodium hydroxide activating solution into the mortar mixer containing the palm leaf ash particles and the watertight concrete powder over 3 minutes at 140±5 rpm, wherein the sodium hydroxide activating solution and the total solid composition are maintained at an activator-to-solid ratio of 0.40:1 and a water-to-solid ratio of 0.30:1 to form a geopolymer precursor composition;
increasing rotational speed of the mortar mixer to 285±10 rpm and continuing mixing for 2-3 minutes to expose the geopolymer precursor composition to the sodium hydroxide activating solution and dissolve silicon-containing species and aluminum-containing species from the palm leaf ash particles to generate dissolved silicon species and dissolved aluminum species distributed within the geopolymer precursor composition;
introducing a quantity of carbon fibers comprising 21 g of carbon fibers corresponding to 1.5 wt. % of a total composite composition into the geopolymer precursor composition during a final 2-minute mixing stage, and continuing operation of the mortar mixer for a total mixing duration of 7-10 minutes to disperse the quantity of carbon fibers throughout the geopolymer precursor composition and form a geopolymer gel surrounding the quantity of carbon fibers;
maintaining interaction between the dissolved silicon species and the dissolved aluminum species within the geopolymer gel to generate an interconnected Si—O—Al aluminosilicate network extending through the geopolymer gel and surrounding the quantity of carbon fibers;
pouring the geopolymer precursor composition into the mold to form a freshly cast geopolymer mixture, positioning the mold on the vibration compaction apparatus, wherein the vibration compaction apparatus comprises a shaker table platform and a vibrator, and actuating the vibrator to generate oscillatory vibration movement at a vibration frequency of 50 Hz, vibration amplitude of 0.4 mm, and vibration duration of 90 seconds, wherein the oscillatory vibration movement propagates through the mold and the freshly cast geopolymer mixture for displacement of entrapped air bubbles and redistribution of constituents throughout the freshly cast geopolymer mixture;
maintaining the mold containing the freshly cast geopolymer mixture at 23-25 °C until drying of the freshly cast geopolymer mixture is completed, and subsequently curing the freshly cast geopolymer mixture in a dry-air oven at 90 °C for 24 hours, followed by ambient curing at 23±2 °C for 90 days, for converting the geopolymer gel into a hardened geopolymer composite board having a rigid aluminosilicate matrix surrounding the quantity of carbon fibers, wherein the interconnected Si—O—Al aluminosilicate network forms geopolymer regions surrounding the quantity of carbon fibers such that crack propagation regions entering carbon-fiber reinforced regions undergo directional deviation along matrix-fiber interface regions and continue through adjacent geopolymer regions positioned between neighboring carbon fibers, and wherein vibration movement generated by the vibration compaction apparatus redistributes the quantity of carbon fibers and geopolymer constituents during the vibration duration such that reinforcement-containing regions positioned through lower, central and upper thickness portions of the freshly cast geopolymer mixture undergo progressive density equalization prior to curing, and wherein geopolymerization comprises sequential formation of aluminosilicate chain regions followed by interconnection of aluminosilicate chain regions into three-dimensional interconnected network regions extending through geopolymer gel portions surrounding the quantity of carbon fibers.

2. The method of claim 1, wherein preparing the palm leaf ash particles further comprises crushing burned palm leaf material followed by subjecting the crushed burned palm leaf material to vibration-assisted filtering through a compact machine operating according to repeated vibration movement, wherein the vibration movement propagates through the crushed burned palm leaf material for separating impurity particles and non-uniform ash agglomerations from the palm leaf ash particles, and wherein vibration-assisted filtering is continued until the palm leaf ash particles introduced into the mortar mixer possess substantially uniform particulate characteristics for promoting homogeneous contact between the palm leaf ash particles and the sodium hydroxide activating solution during subsequent geopolymer precursor formation.

3. The method of claim 1, wherein preparation of the sodium hydroxide activating solution further comprises introducing 100 g of the sodium hydroxide pellets into 300 g of the distilled water while operating the stirrer plate at a rotational speed from 400 rpm to 600 rpm for 10 minutes to 15 minutes, wherein a rotating magnetic field generated by the stirrer plate produces rotational movement of a stir bar immersed within the distilled water to establish continuous circulation of the distilled water and sodium hydroxide pellets throughout a liquid volume, and wherein stirring is maintained until the sodium hydroxide pellets are dissolved throughout the distilled water to form a substantially homogeneous sodium hydroxide activating solution having a sodium hydroxide concentration of 25 wt. %, followed by maintaining the sodium hydroxide activating solution for 2 hours to 4 hours until the sodium hydroxide activating solution reaches 23 °C-25 °C prior to introduction into the mortar mixer.

4. The method of claim 1, wherein formation of the geopolymer precursor composition further comprises operating the mortar mixer according to a sequential multi-stage mixing operation including a first dry mixing stage performed at 140±5 rpm for 2 minutes for distributing 700 g of the palm leaf ash particles and 300 g of the watertight concrete powder, followed by a second mixing stage including gradual addition of the sodium hydroxide activating solution over 3 minutes while maintaining rotational movement at 140±5 rpm, and thereafter increasing rotational speed of the mortar mixer to 285±10 rpm for 2 minutes to 3 minutes, wherein continued rotational mixing establishes repeated contact between the sodium hydroxide activating solution and the palm leaf ash particles for promoting dissolution of silicon-containing species and aluminum-containing species into the geopolymer precursor composition, and wherein continued operation of the mortar mixer subjects the geopolymer precursor composition to an activator-to-solid ratio of 0.40:1 and a water-to-solid ratio of 0.30:1, wherein the sodium hydroxide activating solution remains distributed throughout the geopolymer precursor composition during rotational mixing operation for maintaining dissolution of reactive constituents from the palm leaf ash particles and generating dissolved silicon-containing species and dissolved aluminum-containing species distributed throughout the geopolymer precursor composition prior to geopolymer gel formation.

5. The method of claim 1, wherein introducing the quantity of carbon fibers further comprises gradually introducing 21 g of chopped carbon fibers corresponding to 1.5 wt. % of total composite composition during a final 2-minute mixing stage of the mortar mixer while maintaining rotational movement of the geopolymer precursor composition, wherein the carbon fibers comprise a fiber length from 6 mm to 12 mm, and wherein gradual introduction of the carbon fibers during rotational movement distributes the carbon fibers through interstitial regions of the geopolymer precursor composition and establishes reinforcement regions extending through the geopolymer precursor composition, and wherein continued mixing of the geopolymer precursor composition after introducing the carbon fibers is maintained for a total mixing duration from 7 minutes to 10 minutes, wherein dissolved silicon-containing species and dissolved aluminum-containing species interact within the geopolymer precursor composition to initiate geopolymer gel formation around the carbon fibers and between adjacent carbon fibers, and wherein continued interaction between the dissolved silicon-containing species and dissolved aluminum-containing species forms interconnected Si—O—Al bonds extending through the geopolymer gel and surrounding the carbon fibers to establish an aluminosilicate network extending through the geopolymer precursor composition.

6. The method of claim 1, wherein positioning the mold on the vibration compaction apparatus further comprises placing the mold containing the freshly cast geopolymer mixture on the shaker table platform and actuating vibration movement at a frequency ranging from 40 Hz to 60 Hz, a vibration amplitude ranging from 0.3 mm to 0.5 mm, and a vibration duration ranging from 60 seconds to 120 seconds, including operation at 50 Hz, 0.4 mm amplitude, and 90 seconds, wherein vibration movement propagates through the mold and through the freshly cast geopolymer mixture for displacement of entrapped air bubbles from internal regions of the freshly cast geopolymer mixture toward exposed surfaces of the freshly cast geopolymer mixture while simultaneously redistributing geopolymer constituents throughout the mold, and wherein continued vibration movement through the freshly cast geopolymer mixture is maintained until internal density variation within the freshly cast geopolymer mixture is reduced and geopolymer constituents become substantially uniformly distributed through a mold cavity such that subsequent drying and curing operations convert the geopolymer gel into a hardened geopolymer composite board containing a rigid aluminosilicate matrix surrounding the carbon fibers.

7. The method of claim 1, wherein curing of the freshly cast geopolymer mixture comprises maintaining the mold at 23 °C-25 °C until drying of the freshly cast geopolymer mixture is completed, removing the geopolymer composite board from the mold, curing the geopolymer composite board in a dry-air oven at 90 °C for 24 hours, and maintaining ambient curing at 23±2 °C for 90 days, wherein continued curing converts the geopolymer gel into a rigid aluminosilicate matrix surrounding the carbon fibers and extending throughout the geopolymer composite board.

8. The method of claim 1, wherein dissolution of silicon-containing species and aluminum-containing species from the palm leaf ash particles comprises maintaining continued contact between the sodium hydroxide activating solution and the palm leaf ash particles during operation of the mortar mixer such that alkaline exposure progressively dissolves surface regions of the palm leaf ash particles and forms dissolved silicon-containing species and dissolved aluminum-containing species distributed through the geopolymer precursor composition, and wherein the dissolved silicon-containing species and dissolved aluminum-containing species undergo migration through liquid-filled regions of the geopolymer precursor composition during the total mixing duration of 7 minutes to 10 minutes prior to geopolymer gel formation, and wherein continued operation of the mortar mixer at 285±10 rpm following introduction of the sodium hydroxide activating solution subjects the geopolymer precursor composition to repeated circulation movement causing the dissolved silicon-containing species and dissolved aluminum-containing species to occupy regions surrounding the quantity of carbon fibers, wherein geopolymer gel formation is initiated simultaneously at carbon-fiber adjacent regions and matrix regions positioned between adjacent carbon fibers for forming interconnected reaction regions extending through the geopolymer precursor composition.

9. The method of claim 1, wherein introducing the quantity of carbon fibers further comprises gradually introducing the quantity of carbon fibers during the final 2-minute mixing stage in a progressive addition sequence while maintaining rotational movement of the mortar mixer, wherein the quantity of carbon fibers enters the geopolymer precursor composition in successive portions distributed over the final 2-minute mixing stage for reducing carbon-fiber accumulation regions and establishing substantially uniform carbon-fiber spacing through the geopolymer precursor composition, and wherein the quantity of carbon fibers comprises chopped carbon fibers having a fiber length from 6 mm to 12 mm, and wherein continued rotational movement of geopolymer precursor composition positions individual carbon fibers through interstitial regions located between geopolymer precursor material portions such that geopolymer gel formation occupies regions surrounding individual carbon fibers and forms embedded crack-bridging reinforcement regions extending through a board thickness direction.

10. The method of claim 1, wherein generation of the interconnected Si—O—Al aluminosilicate network comprises continued interaction between dissolved silicon-containing species and dissolved aluminum-containing species following carbon fiber introduction, wherein the interconnected Si—O—Al aluminosilicate network propagates through geopolymer gel regions positioned around the quantity of carbon fibers and between adjacent geopolymer gel regions to establish a three-dimensional aluminosilicate network extending continuously throughout the geopolymer precursor composition, and wherein formation of the interconnected Si—O—Al aluminosilicate network comprises progressive geopolymerization stages including dissolution of reactive species from the palm leaf ash particles, geopolymer gel generation, network growth around the quantity of carbon fibers and conversion of the geopolymer gel into a rigid aluminosilicate matrix during curing, wherein the progressive geopolymerization stages occur sequentially throughout the curing.

11. The method of claim 1, wherein actuating the vibration compaction apparatus at 50 Hz, 0.4 mm amplitude and 90 seconds vibration duration produces oscillatory movement propagating through a lower mold region and an upper mold region such that entrapped air bubbles positioned within interior regions of the freshly cast geopolymer mixture undergo movement toward exposed upper surfaces of the freshly cast geopolymer mixture and air-containing regions within the freshly cast geopolymer mixture become progressively reduced during continued vibration movement, and wherein continued vibration movement through the freshly cast geopolymer mixture simultaneously redistributes the quantity of carbon fibers and geopolymer constituents through a mold cavity during the vibration duration of 90 seconds, wherein repeated oscillatory propagation reduces density variation between central and peripheral mold regions prior to drying of the freshly cast geopolymer mixture.

12. The method of claim 1, wherein maintaining the mold containing the freshly cast geopolymer mixture at 23 °C to 25 °C during drying comprises maintaining the freshly cast geopolymer mixture under laboratory ambient conditions prior to dry-air curing such that residual liquid regions within the freshly cast geopolymer mixture undergo progressive moisture reduction before demolding of the geopolymer composite board.

13. The method of claim 1, wherein curing at 90 °C for 24 hours followed by ambient curing at 23±2 °C for 90 days comprises maintaining the geopolymer composite board under a first curing stage sufficient to accelerate geopolymer reaction progression and a second curing stage sufficient to continue conversion of geopolymer gel regions into a hardened geopolymer composite board containing a rigid aluminosilicate matrix extending around the quantity of carbon fibers and throughout the geopolymer composite board.

14. The method of claim 1, wherein introducing the quantity of carbon fibers comprises positioning a carbon fiber mesh within an interior region of the mold prior to introduction of the geopolymer precursor composition and further introducing randomly dispersed short carbon fibers into the geopolymer precursor composition during the final 2-minute mixing stage such that the carbon fiber mesh occupies a board-thickness reinforcement region and the randomly dispersed short carbon fibers occupy matrix regions surrounding the carbon fiber mesh within the geopolymer composite board.

15. The method of claim 1, wherein geopolymerization within the geopolymer precursor composition proceeds through sequential reaction stages comprising dissolution of silicon-containing species and aluminum-containing species from the palm leaf ash particles, formation of geopolymer gel regions containing dissolved silicon-containing species and dissolved aluminum-containing species, propagation of interconnected Si—O—Al aluminosilicate network regions around the quantity of carbon fibers, and conversion of the interconnected Si—O—Al aluminosilicate network regions into the rigid aluminosilicate matrix during curing, and wherein the interconnected Si—O—Al aluminosilicate network generated during curing extends around exposed surface regions of the quantity of carbon fibers and forms geopolymer anchoring regions positioned between adjacent carbon fibers and surrounding geopolymer matrix regions.

16. The method of claim 1, wherein vibration movement generated by the vibration compaction apparatus propagates through lower mold regions, central mold regions and upper mold regions during the vibration duration of 90 seconds such that geopolymer constituents positioned through different thickness regions of the freshly cast geopolymer mixture undergo redistribution and density equalization through board thickness direction, and wherein continued mixing and curing of the geopolymer precursor composition positions the quantity of carbon fibers through matrix regions of the geopolymer composite board in a distributed arrangement such that crack propagation regions generated under compressive loading extend across multiple carbon-fiber reinforcement regions.

17. The method of claim 1, wherein the quantity of carbon fibers is distributed through the geopolymer precursor composition according to a reinforcement arrangement comprising randomly dispersed reinforcement regions and aligned reinforcement regions extending through separate portions of the geopolymer precursor composition such that geopolymer gel formation occurs around carbon fibers positioned according to different reinforcement orientations within the geopolymer precursor composition.

18. The method of claim 1, wherein gradual introduction of the sodium hydroxide activating solution and subsequent increase of mortar mixer rotational speed establishes a temporally staged dissolution regime in which silicon-containing species and aluminum-containing species are released from the palm leaf ash particles at non-uniform reaction rates over successive mixing intervals, such that geopolymer gel formation initiates after establishment of substantially homogeneous alkaline exposure throughout the geoploymer precursor composition, thereby reducing localized gel nucleation regions and generating an aluminosilicate matrix having reduced concentration gradients surrounding carbon-fiber reinforcement regions and wherein the quantity of carbon fibers dispersed within the geopolymer precursor composition becomes encapsulated by the interconnected Si—O—Al aluminosilicate network to generate distributed fiber-bridging regions configured to alter crack propagation behavior during compressive loading by promoting crack deflection, crack branching, and localized energy dissipation within the geopolymer composite board, thereby changing fracture progression from continuous longitudinal propagation toward discontinuous multi-region crack development.
